(19) United States
(12) Patent Application Publication
(10) Pub. No.: US 2008/0184081 A1
(43) Pub. Date: Jul. 31, 2008

(54) DATA COMMUNICATION APPARATUS, METHOD, AND PROGRAM

(76) Inventors: TAKAYUKI HAMA, Tokyo (JP); Norihito Fujita, Tokyo (JP)

Correspondence Address: NEC CORPORATION OF AMERICA, 6535 N. STATE HWY 161, IRVING, TX, 75039, US

(21) Appl. No.: 12/021,084

(22) Filed: Jan. 28, 2008

(30) Foreign Application Priority Data
Jan. 29, 2007 (JP) 2007-017738

(51) Int. Cl. G06F 11/00

(52) U.S. Cl. 714/708; 714/E11.001

(57) ABSTRACT

A data communication apparatus determines whether the error type is a burst error or not based on an error occurrence state of the data received from a data transmitting apparatus and transmits error type-basis error information. The data communication apparatus receives the error type-basis error information and sets the redundancy degree of an FEC processing section based on the error rate of the errors other than a burst error.

### CROSS-REFERENCE TO RELATED APPLICATION

This application is based upon and claims the benefit of priority from Japanese patent application No. 2007-017738, filed Jan. 29, 2007, the disclosure of which is incorporated herein in its entirety by reference.

### BACKGROUND OF THE INVENTION

1. Field of the Invention

The present invention relates to a data communication and, more particularly, to a method for determining a cause of communication quality degradation and communication control performed based on the determined cause.

2. Description of the Related Art

In data communication, data error may occur due to bit inversion on a transmission path or packet loss caused by buffer overflow at a router on a packet network. As a restoration technique against the data error, there are available techniques such as ARQ (Automatic Repeat Request) in which a receiving side requests a part of the data to be retransmitted from a transmission side, FFC (Forward Error Correction) in which data is previously made redundant at the transmission time so that original data can be restored even if an error occurs in a part of the data, and the like.

In the FFC, a linear block code is widely used. A typical linear block code is a Reed Solomon code. In the linear block code, signal length for each block is referred to as k (information length), signal length obtained by multiplying the FFC is as n (code length), code of the code length n and information length k is as (n,k) code. Redundancy is represented by n−k.

In the present specification, a change of redundancy degree means that the redundancy or information length is changed so as to change error tolerance. To increase the error tolerance, there are available two ways; one is to increase the redundancy while maintaining the information length constant, and the other is to decrease the information length while maintaining the redundancy constant. Further, to decrease the error tolerance or to reduce the amount of redundant data, there are available two ways; one is to decrease the redundancy while maintaining the information length constant, and the other is to increase the information length while maintaining the redundancy constant. There are available two methods for changing the redundancy; in the first method, the information length is not changed but code length is changed to change the size of the redundant data, and in the second method, large redundant data is previously created and, afterwards, the size of the data actually transmitted as redundant data is changed. In the present specification, the code length that has actually been transmitted is represented as n′, and a value obtained by (n′−k)/n′ is referred to as redundancy degree.

When the ARQ is used as a restoration technique, data integrity is guaranteed. However, at the retransmission time, data is delayed by a time corresponding to round-trip delay time until the completion of the retransmission. Thus, at an area where a large delay occurs, data arrival time greatly varies due to the retransmission operation and, therefore, the ARQ is not suitable to a traffic with a high real-time demand. Further, when an error rate is increased, an error is correspondingly more likely to occur also in the retransmitted data. In this case, accordingly, re-retransmission needs to be made, which takes more time to complete restoration.

When the FEC is used as a restoration technique, redundancy degree suitable to the error ratio on a network cannot be obtained in some cases, since the redundancy degree is fixed. For example, when the redundancy of the FEC is insufficient, data cannot completely be restored. When the redundancy degree is excessively high, frequency band of the network is unnecessarily used.

As described above, the data restoration technique to be used differs depending on the state of a network. Further, in the FEC, the optimal redundancy degree differs depending on the state of a network. Under the circumstances, there is proposed a technique that changes control performance of the data restoration technique depending on the state of a network.

Related art documents relating to the above-described technique includes the following: JP-A-2002-141964; JP-A-2005-175837; and Jun Takahashi, Hideki Tode, and Kozo Murakami; An Efficient FEC Method Using Packet-level Convolution; The Institute of Electronics, Information and Communication Engineers Vol. 105, No. 278, September 2005, p.p. 91 to 94, NS2005-96.

A system disclosed in JP-A-2002-141964 measures statistical information concerning packet propagation delay time or packet loss at a statistical information observation means on a receiving terminal side and, based on the statistical information, requests a transmitting terminal side to change an error correction method. For example, a change of the method from FEC to ARQ or a change in the FEC redundancy degree can be made.

A system disclosed in JP-A-2005-175837 determines a congestion state based on a variation in RTT (Round Trip Time) at a congestion/non-congestion determination section. When determining the congestion state, the system changes the redundancy degree of the FEC.

In the related art, a network state is determined based on the statistical information concerning an error. Accordingly, when a temporary burst error occurs to increase the error rate indicated by the statistical information, the redundancy degree of the FEC optimal to the increased error rate is set. However, unlike a non-burst error (a state where an error occurs singly), a burst error (a state in which errors occur successively) is difficult to correct with the FEC, so that the advantage obtained by increasing the redundancy degree is small; conversely, an adverse effect caused by excessively increasing the FEC redundancy degree from a redundancy degree required at the steady state is significant.

Further, in the related art, the FEC redundancy degree is changed depending on the error rate and the like. Thus, in the case of a communication apparatus having a communication speed control function of setting the communication speed based on an error or in accordance with an increase or decrease of delay amount, it is impossible to change FEC parameters in cooperation with the communication speed control function. Consequently, the communication speed control function cannot be utilized for changing the FEC redundancy degree.

### SUMMARY OF THE INVENTION

An object of the present invention is to provide a communication apparatus capable of setting the optimal FEC redundancy degree.

Another object of the present invention is to provide a communication apparatus capable of changing the FEC parameters in cooperation with a communication speed control function.

According to one aspect of the present invention, there is provided a data communication apparatus for transmitting/receiving data through a communication network using an FEC which is a code for applying redundancy to the data, comprising: means for determining whether the error type, which is information concerning the pattern of an error of the data occurring on the network, is a burst error or not; and means for changing the redundancy degree of the FEC based on the error type.

Further, the present invention acquires communication speed from a communication speed control function for setting communication speed in accordance with the increase/decrease of an error or delay amount and calculates the optimal FEC parameters in accordance with the communication speed.

By determining whether an error that has occurred is a burst error or not and setting the redundancy degree of the FEC to the optimal value for errors other than the burst error, it is possible to prevent the FEC redundancy degree from excessively increased.

Further, by calculating the optimal FEC parameter in accordance with the communication speed acquired from the communication speed control function, it is possible to enable the FEC parameters to be changed in cooperation with the communication speed control function.

According to the present invention, it is possible to set the optimal FEC parameters in accordance with a state of the network. This is because that whether the error type which is information concerning the pattern of an error of the data occurring on the communication network is a burst error or not and, according to the determined error type, the FEC redundancy is changed.

Further, according to the present invention, it is possible to change the FEC parameters in cooperation with the communication speed control function. This is because that the optimal FEC parameters are calculated in accordance with the communication speed acquired from the communication speed control function.

### BRIEF DESCRIPTION OF THE DRAWINGS

FIG. 1 is a block diagram showing the entire configuration of a first exemplary embodiment of the present invention;

FIG. 2 is a block diagram showing a data transmitting apparatus and data receiving apparatus in the first exemplary embodiment of the present invention;

FIG. 3 is a flowchart showing the operation of the data transmitting apparatus according to the first exemplary embodiment of the present invention;

FIG. 4 is a flowchart showing the operation of the data receiving apparatus according to the first exemplary embodiment of the present invention;

FIG. 5 is a block diagram showing the data transmitting apparatus and data receiving apparatus in a second exemplary embodiment of the present invention;

FIG. 6 is a flowchart showing the operation of the data transmitting apparatus according to the second exemplary embodiment of the present invention;

FIG. 7 is a flowchart showing the operation of the data receiving apparatus according to the second exemplary embodiment of the present invention;

FIG. 8 is a block diagram showing the data transmitting apparatus and data receiving apparatus in a third exemplary embodiment of the present invention;

FIG. 9 is a flowchart showing the operation of the data transmitting apparatus according to the third exemplary embodiment of the present invention;

FIG. 10 is a flowchart showing the operation of the data receiving apparatus according to the third exemplary embodiment of the present invention;

FIG. 11 is a block diagram showing the data transmitting apparatus and data receiving apparatus in a fourth exemplary embodiment of the present invention;

FIG. 12 is a flowchart showing the operation of the data transmitting apparatus according to the fourth exemplary embodiment of the present invention;

FIG. 13 is a block diagram showing the data transmitting apparatus and data receiving apparatus in a fifth exemplary embodiment of the present invention;

FIG. 14 is a flowchart showing the operation of the data transmitting apparatus according to the fifth exemplary embodiment of the present invention;

FIG. 15 is a flowchart showing the operation of the data receiving apparatus according to the fifth exemplary embodiment of the present invention;

FIG. 16 is a block diagram showing the data transmitting apparatus and data receiving apparatus in a sixth exemplary embodiment of the present invention; and

FIG. 17 is a flowchart showing the operation of the data receiving apparatus according to the sixth exemplary embodiment of the present invention.

### DETAILED DESCRIPTION OF THE PREFERRED EXEMPLARY EMBODIMENTS

Preferred exemplary embodiments of the present invention will be described in detail with reference to the accompanying drawings.

### First Exemplary Embodiment

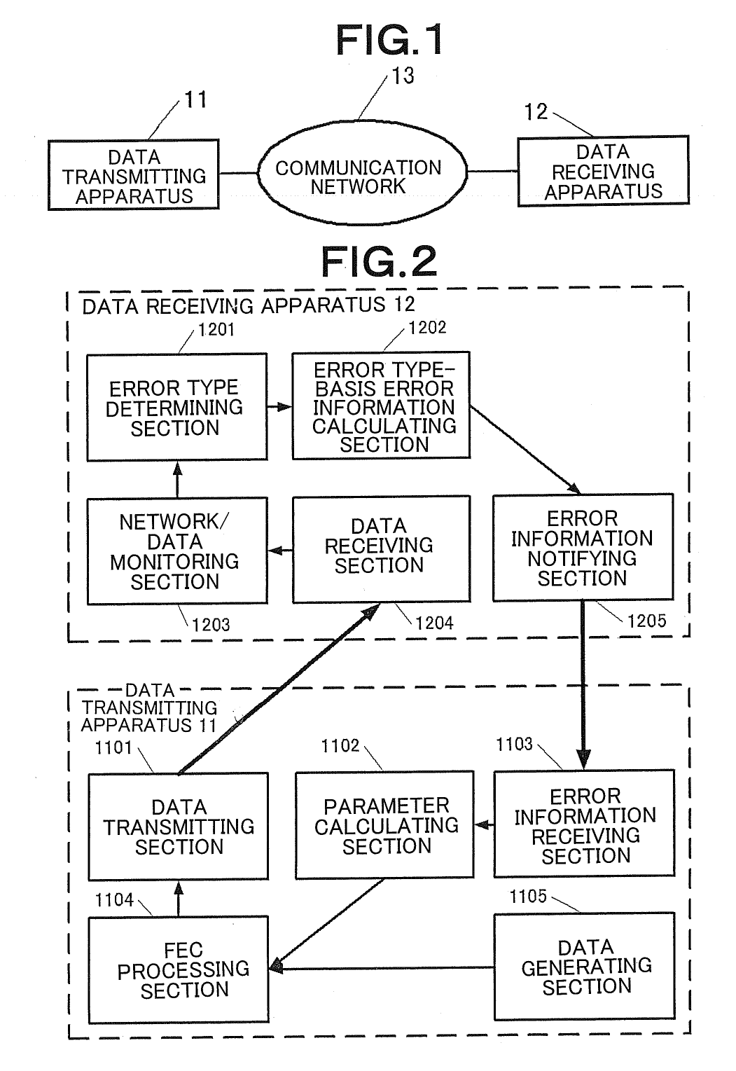

Referring to FIG. 1, a first exemplary embodiment of the present invention includes a data transmitting apparatus 11 for transmitting data and a data receiving apparatus 12 for receiving data from the data transmitting apparatus 11. The data transmitting apparatus 11 and data receiving apparatus 12 are connected to each other through a communication network 13.

Referring to FIG. 2, the data transmitting apparatus 11 includes a data transmitting section 1101, a parameter calculating section 1102, an error information receiving section 1103, an FEC processing section 1104, and data generating section 1105.

The data transmitting section 1101 is a means for transmitting data to the data receiving apparatus 12. The parameter calculating section 1102 is a means for calculating FEC parameters based on error information notified from the error information receiving section 1103. The error information receiving section 1103 is a means for receiving error information from the data receiving apparatus 12. The FEC processing section 1104 is a means for performing FEC processing for data from the data generating section 1105 according to the parameters calculated by the parameter calculating section 1102. The algorism of the FEC used is not particularly limited and may be any suitable one.

Referring to FIG. 2, the data receiving apparatus 12 includes an error type determining section 1201, an error type-basis error information calculating section 1202, a network/data monitoring section 1203, a data receiving section 1204, and an error information notifying section 1205.

The network/data monitoring section 1203 is a means for monitoring the error information that data itself has and a state of a network. The error type determining section 1201 is a means for determining the type of an error based on the information received from the network/data monitoring section 1203. The error type-basis error information calculating section 1202 is a means for calculating the error information for each error type determined by the error determining section 1201. The data receiving section 1204 is a means for receiving data from the data transmitting apparatus 11. The error information notifying section 1205 is a means for transmitting the error information calculated by the error type-basis error information calculating section 1202 to the data transmitting apparatus 11.

The operation in the present exemplary embodiment will next be described.

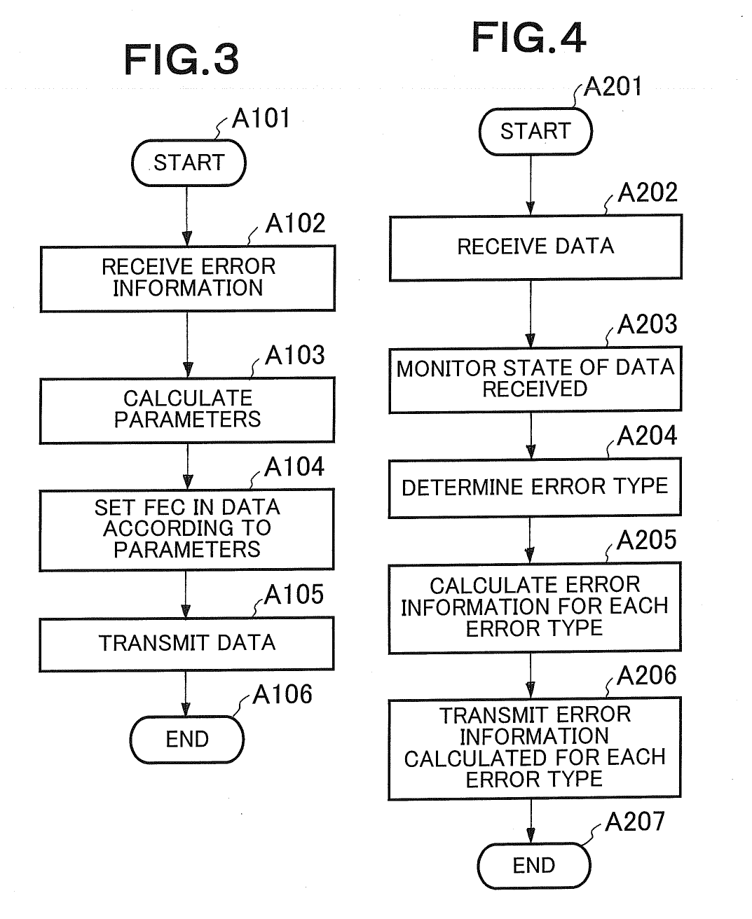

Referring to FIG. 3, in the data transmitting apparatus 11, the error information receiving section 1103 receives the error information transmitted from the data receiving apparatus 12 (step A102 of FIG. 3). Then, the parameter calculating section 1102 calculates parameters according to the error information (step A103 of FIG. 3). Subsequently, according to the calculated parameters, the FEC processing section 1104 sets the FEC in the data from the data generating section 1105 (step A104 of FIG. 3). Finally, the data transmitting section 1101 transmits to the data receiving apparatus 12 the data in which the FEC has been set (step A105 of FIG. 3).

Referring to FIG. 4, in the data receiving apparatus 12, the data receiving section 1204 receives the data transmitted from the data transmitting apparatus 11 (step A202). Then, the network/data monitoring section 1203 monitors a state of the received data or state of the network (step A203). Subsequently, the error type determining section 1201 determines the error type based on the state monitored by the network/data monitoring section 1203 (step A204). Subsequently, based on the error type and state of the data or network, the error type-basis error information calculating section 1202 calculates error information for each error type (step A205). Finally, the error information notifying section 1205 notifies the data transmitting apparatus 11 of the error information calculated for each error type (step A206).

The respective components provided in the data receiving apparatus 12 and data transmitting apparatus 11 will next be described in detail.

First, the network/data monitoring section 1203 will be described in detail.

The network/data monitoring section 1203 monitors, e.g., the following information.

(1) Error Information
a) Information indicating presence/absence of error in received data
b) Information indicating presence/absence of error after application of FEC correction
c) Error rate, size of successive errors, location of generation of error (regarding received data)
d) Error rate, size of successive errors, location of generation of error (regarding data after application of FEC correction)

(2) Network Information
a) Transmission delay (delay time)
b) Data arrival order
c) Signal condition

The network/data monitoring section 1203 need not monitor all the above information but may monitor a part of the above information. The transmission delay (delay time) is calculated as follows. That is, the data transmitting section 1101 adds transmission time as optional information to transmission data, and data receiving section 1204 adds data reception time to the received data, and network/data monitoring section 1203 calculates the transmission delay by subtracting the reception time from the transmission time.

The error type determining section 1201 will next be described in detail.

The error type determining section 1201 determines the type of an error based on the information monitored by the network/data monitoring section 1203. For example, whether an error generated has a burst error pattern or not can be determined based on the error rate after application of error correction or by comparing the sizes of successive errors before and after application of error correction with a predetermined threshold value.

Further, the error type determining section 1201 may determine the error type in consideration of communication speed in addition to the information monitored by the network/data monitoring section 1203. The communication speed mentioned here is the data communication speed measured by the data receiving section 1204 and is the size of received data per unit time. The higher the communication speed is, the more likely an error due to congestion is to occur.

Further, the error type determining section 1201 may determine the error type in consideration of variation in the communication speed with time in addition to the information monitored by the network/data monitoring section 1203. The variation in the communication speed with time is measured by the data receiving section 1204. When the variation in the communication speed with time becomes large in the positive direction, an error due to congestion is likely to occur.

The error type may be determined by two values representing whether the data or network falls in a given state, may be determined by three values representing whether the data or network falls in a state A, a state B or a state other than A and B, or may be determined by multi-values more than three values. Further, a combination of two-value determinations may be used with respect to n states which are independent of each other. For example, whether an error has a burst error pattern or not can be determined by two values. The burst error denotes a state in which errors occur successively.

In order to distinguish an error state by determining a cause of the burst error more closely, multi-values are used. For example, the multi-values are used to individually determine states, such as “error occurring in transmission path”, “error caused due to path fluctuation”, and “packet loss error caused due to congestion”. The above burst error types may be determined alone or in combination. The state “error occurring in transmission path” can be determined by detecting that an error occurs in the data information itself or that a signal condition becomes deteriorated. The state “error is caused due to path fluctuation” can be determined by detecting the out-of-order of data arrival. The state “packet loss error is caused due to congestion” can be determined by detecting that data loss occurs in a repeater itself due to congestion.

In a packet network, data error occurring in a lower protocol layer may cause packet loss. In order to distinguish the packet loss caused due to the data error from packet loss caused due to buffer overflow in the repeater at the congestion time, a variation in the communication speed per unit time is used as a determination criterion. When the variation is large, the packet loss is determined to be one due to the congestion; while the variation is small, the packet loss is determined to be one due to a cause other than the congestion. Further, the length of delay time can be used as a criterion for determining whether the packet loss is caused due to the data error or congestion. The reason is as follows. The data error occurs irrespective of the delay time; while whether the packet loss due to the congestion occurs or not depends on the buffer size of the repeater in which the packet loss occurs. Thus, the packet loss due to the congestion is likely to be concentrated near the delay time point (obtained by delay time of a transmission path+relay buffer). Therefore, it is possible to determine whether the packet loss is caused due to the data error or congestion by setting a given threshold in the delay time.

The error type-basis error information calculating section 1202 will next be described in detail.

Examples of the parameters relating the error information that the error type-basis error information calculating section 1202 calculates for each error type include “presence/absence of error”, “number of occurrences of error”, “error size”, “size of non-error portion”, “error rate”, “size of successive errors”, “transmission delay”, “size of retransmitted data”, and “number of retransmissions”. Each of the error information described above may be a value before application of error correction by the FEC or after application of the error correction. Further, all the above error information need not be calculated but they may be calculated alone or in combination. Further, different error information may be calculated for each error type.

The parameter calculating section 1102 will next be described in detail.

The parameter calculating section 1102 determines whether the FEC parameters need to be changed or not according to the error information that the error type-basis error information calculating section 1202 calculates for each error type and changes the parameters, if needed. Assume here that the error type is determined by two values representing whether an error has a burst error pattern or not. In this case, when all the errors that have occurred has burst patterns, the parameter calculating section 1102 does not change the FEC redundancy degree; when an error that has not burst error pattern occurs, the parameter calculating section 1102 changes the FEC redundancy degree so that error having an error rate different from the error rate of the burst error calculated by the error type-basis error information calculating section 1202 can be restored.

Further, in the case where the error type is determined by three values representing “error occurring in transmission path”, “error caused due to path fluctuation”, and “packet loss error caused due to congestion” or determined by two values representing “error occurring in transmission path”, and “packet loss error caused due to congestion”, the parameter calculating section 1102 may change, according to quality requirement of an application, the current redundancy degree to a redundancy degree corresponding to the error rate calculated by the error type-basis error information calculating section 1202 so that even the error occurring in a transmission path can be restored by the FEC; otherwise, the parameter calculating section 1102 does not change the redundancy degree. Further, by combining determinations whether the error type is “error occurring in transmission path” and whether the error has a burst error pattern, it is possible to determine, for example, that the error occurs in a transmission line and that all the errors that have occurred therein are burst errors. In this case, the parameter calculating section 1102 does not change the FEC redundancy degree.

Examples of the parameters that the parameter calculation section 1102 can change may include a parameter defining whether the FEC is used or not and a parameter defining FEC algorithm (method) in addition to the parameter defining the redundancy degree. That is, the FEC processing section 1104 can achieve the redundancy degree specified by a redundancy degree parameter given by the parameter calculating section 1102, as well as it can control from outside whether the FEC is used or not based on a parameter defining that and can control from outside which algorithm is to be used based on a parameter for selecting an algorithm used. When the parameter given by the parameter calculating section 1102 indicates a value specifying a use of the FEC, the FEC processing section 1104 executes processing according to the FEC; on the other hand, when the parameter indicates a value that does not specify the use of the FEC, the FEC processing section 1104 does not execute processing according to the FEC. Further, a configuration may be adopted in which when the redundancy degree specified by the redundant parameter is 0, the FEC processing section 1104 does not apply the FEC. Further, the FEC processing section 1104 can control from outside which algorithm is to be used based on a parameter for selecting an algorithm used and executes the FEC according to the algorithm specified by the parameter given by the parameter calculating section 1102. Assuming, for example, that there exist two algorithms; one is an algorithm having a high coding efficiency but low calculating efficiency, and the other is an algorithm having a low coding efficiency but high calculating efficiency, the algorism having a low coding efficiency but high calculating efficiency is used when the error amount is small; on the other hand, the algorism having a high coding efficiency but low calculating efficiency is used when the error amount is large.

The effect of the present exemplary embodiment will next be described.

According to the present exemplary embodiment, it is determined whether the error type is a burst error or not and, based on the determination, the FEC redundancy degree suitable to errors other than the burst error is set. Thus, it is possible to prevent the FEC redundancy degree from being excessively increased, thereby preventing unnecessary use of the frequency band of the network.

Further, according to the present exemplary embodiment, when notifying error information to the transmission side, the receiving side calculates error information for each error type to condense the information to be notified. As a result, the amount of information to be notified to the transmission side can be reduced as compared to a case where the receiving side transits motoring data itself directly to the transmission side.

### Second Exemplary Embodiment

A second exemplary embodiment of the present invention will next be described in detail.

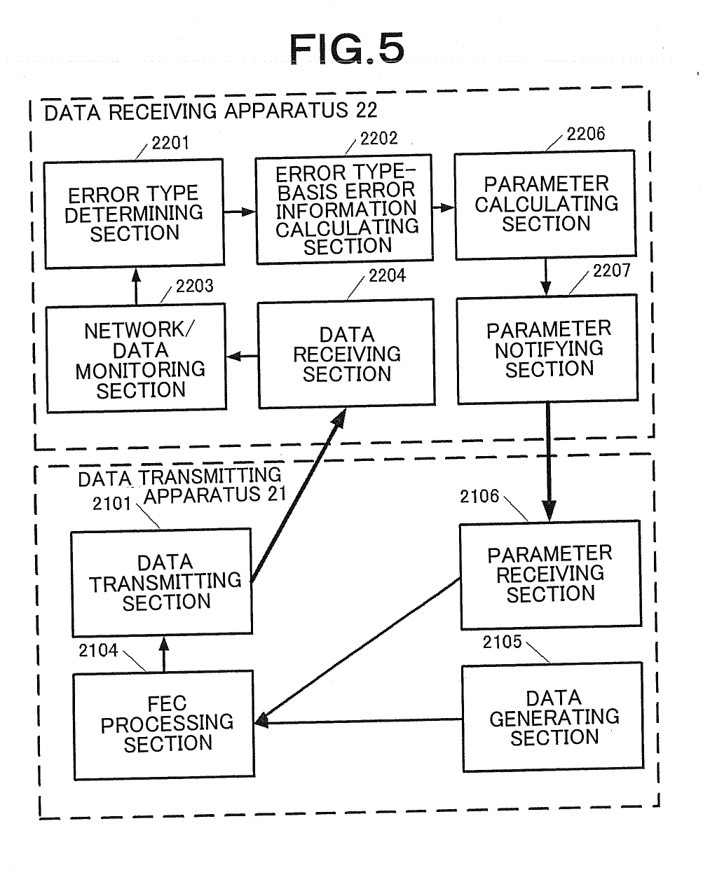

Referring to FIG. 5, a second exemplary embodiment of the present invention includes a data transmitting apparatus 21 for transmitting data and a data receiving apparatus 22 for receiving data from the data transmitting apparatus 21. Although not shown, the data transmitting apparatus and data receiving apparatus are connected to each other through a communication network as in the case of the first exemplary embodiment. This is the same in the following exemplary embodiments.

The data transmitting apparatus 21 includes a data transmitting section 2101, a parameter receiving section 2106, an FEC processing section 2104, and a data generating section 2105.

The data transmitting section 2101 is a means for transmitting data to the data receiving apparatus 22. The parameter receiving section 2106 is a means for receiving FEC parameters transmitted from the data receiving apparatus 22. The FEC processing section 2104 is a means for performing FEC processing for data from the data generating section 2105 according to the parameters received by the parameter receiving section 2106. The FEC processing section 2104 performs the FEC processing in the same manner as the FEC processing section 1104 of FIG. 2 does.

The data receiving apparatus 22 includes an error type determining section 2201, an error type-basis error information calculating section 2202, a parameter calculating section 2206, a network/data monitoring section 2203, a data receiving section 2204, and a parameter notifying section 2207.

The functions of the data receiving section 2204, network/data monitoring section 2203, and error type determining section 2201 are the same as those of the data receiving section 1204, network/data monitoring section 1203, and error type determining section 1201 shown in FIG. 2. The parameter calculating section 2206 is a means for calculating parameters according to the error type-basis error information from the error type-basis error information calculating section 2202. The parameter calculating section 2206 calculates the parameters in the same manner as the error type-basis error information calculating section 1202 of FIG. 2 does. The parameter notifying section 2207 is a means for notifying the data transmitting apparatus 21 of the parameters.

The operation in the present exemplary embodiment will next be described.

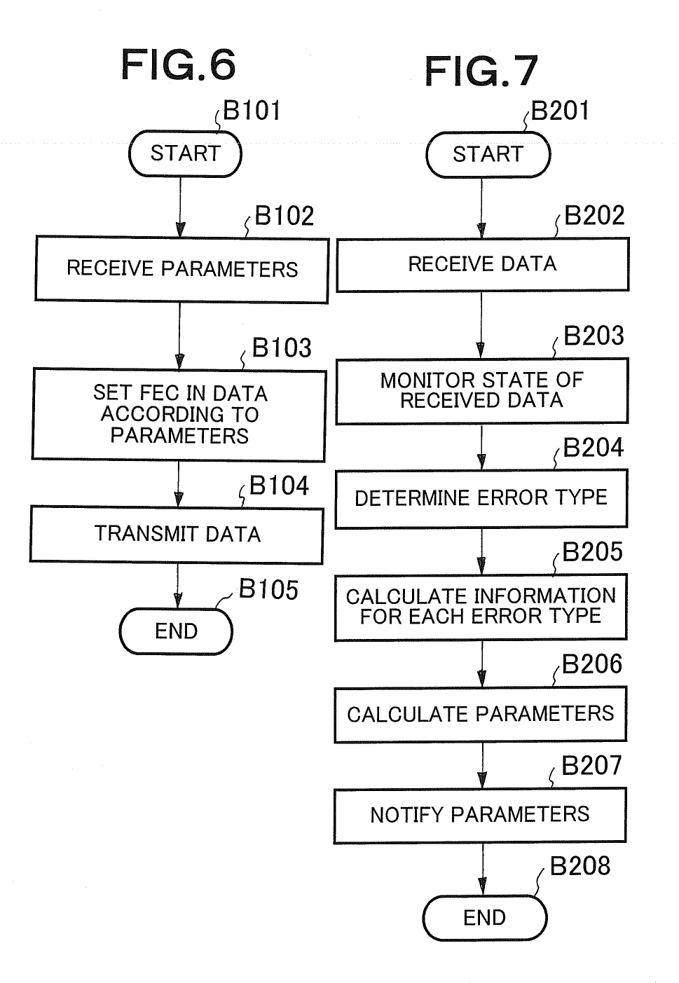

Referring to FIG. 6, in the data transmitting apparatus 21, the parameter receiving section 2106 receives FEC parameters transmitted from the data receiving apparatus 22 (step B102 of FIG. 6). Then, according to the received FEC parameters, the FEC processing section 2104 sets the FEC in the data from the data generating section 2105 (step B103 of FIG. 6). Finally, the data transmitting section 2101 transmits to the data receiving apparatus 22 the data in which the FEC has been set (step B104 of FIG. 6).

Referring to FIG. 7, in the data receiving apparatus 22, the data receiving section 2204 receives the data transmitted from the data transmitting apparatus 21 (step B202). Then, the network/data monitoring section 2203 monitors a state of the received data or state of the network (step B203). Subsequently, the error type determining section 2201 determines the error type based on the state monitored by the network/data monitoring section 2203 (step B204). Subsequently, based on the error type and state of the data or network, the error type-basis error information calculating section 2202 calculates error information for each error type (step B205). Subsequently, the parameter calculating section 2206 calculates FEC parameters according to the error information for each error type (step B206). Finally, the parameter notifying section 2207 transmits the calculated FEC parameters to the data transmitting apparatus 21 (step B207).

The effect of the present exemplary embodiment will next be described.

According to the present exemplary embodiment, the same effect as the first exemplary embodiment can be obtained. Further, the data receiving apparatus 22 calculates the FEC parameters and transmits them to the data transmitting apparatus 21, so that the amount of data sent over the network can be reduced as compared to the first exemplary embodiment.

### Third Exemplary Embodiment

A third exemplary embodiment of the present invention will next be described in detail.

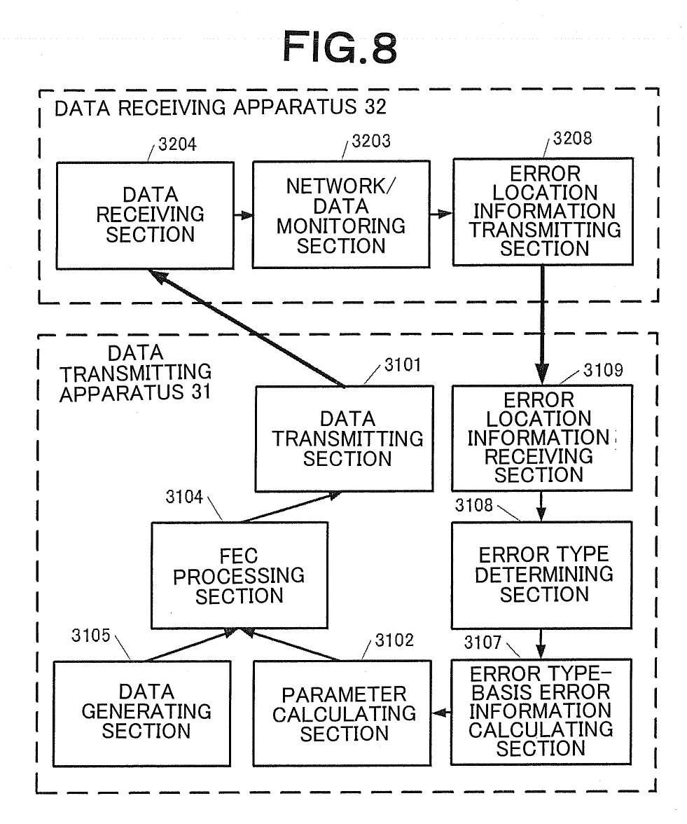

Referring to FIG. 8, a third exemplary embodiment of the present invention includes a data transmitting apparatus 31 for transmitting data and a data receiving apparatus 32 for receiving data from the data transmitting apparatus 31.

The data transmitting apparatus 31 includes a data transmitting section 3101, an FEC processing section 3104, a data generating section 3105, a parameter calculating section 3102, an error type-basis information calculating section 3107, an error type determining section 3108, and an error location information receiving section 3109.

The functions of the data transmitting section 3101, FEC processing section 3104, data generating section 3105, and parameter calculating section 3102 are the same as those of the data transmitting section 1101, FEC processing section 1104, data generating section 1105, and parameter calculating section 1102 shown in FIG. 2. The functions of the error type-basis information calculating section 3107 and error type determining section 3108 are the same as those of the error type-basis error information calculating section 1202 and error type determining section 1201 shown in FIG. 2. However, in the present exemplary embodiment, the error type-basis information calculating section and error type determining section are provided in the data transmitting side. The error location information receiving section 3109 is a means for receiving error information from the data receiving apparatus 32.

The data receiving apparatus 32 includes a network/data monitoring section 3203, data receiving section 3204, and an error location information transmitting section 3208.

The function of the data receiving section 3204 is the same as that of the data receiving section 1204 of FIG. 2. Of the functions that the network/data monitoring section 1203 of FIG. 2 has, the network/data monitoring section 3203 achieves at least a function of monitoring the location at which an error has occurred after application of FEC correction. The error location information transmitting section 3208 is a means for transmitting error location information to the data transmitting apparatus 31.

The error location information is information that explicitly indicates the location at which a data error has occurred. As a concrete method for notifying the error location information, there are available a method (ACK: Acknowledgement) of giving notice of the sequence number of the data that has arrived in the data receiving apparatus 32, a method (NACK: Negative Acknowledgement) of giving notice of the sequence number of the data that has not arrived in the data receiving apparatus 32, and a method of combining the above two. When the error location information is notified, at least one of information concerning data-loss before application of FEC correction (state of data) and transmission delay, data arrival order, and signal condition (state of transmission path) may be added to the error location information.

The error location information receiving section 3109 has also a function of monitoring the transmission time of given data and reception time of information concerning the error location of the given data and calculating a difference between the two values, thereby measuring round-trip delay which is information concerning the network quality.

The operation in the present exemplary embodiment will next be described.

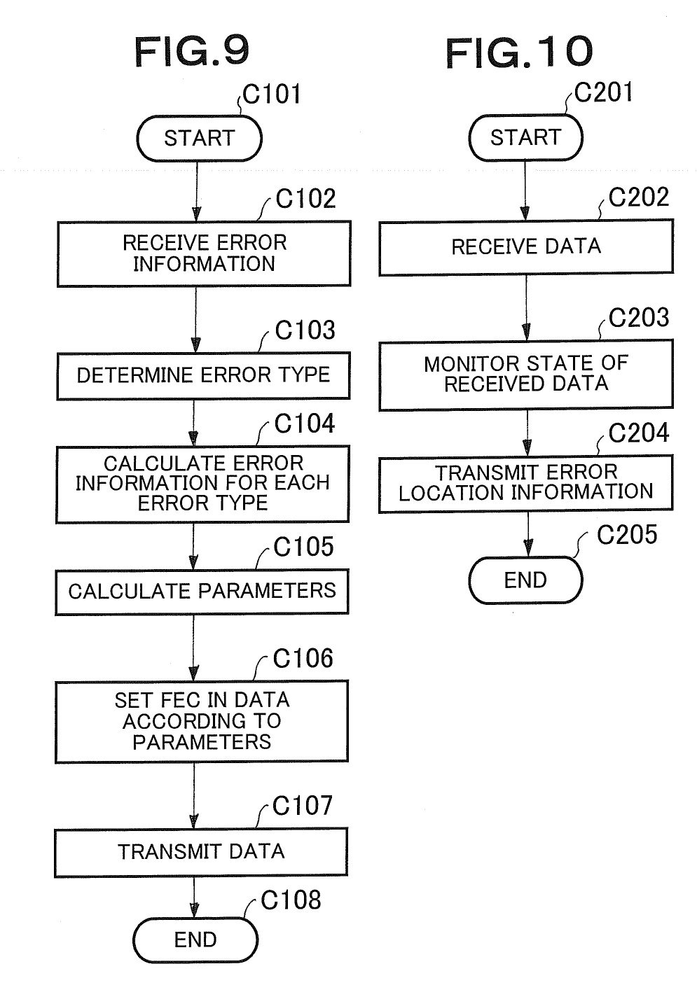

Referring to FIG. 9, in the data transmitting apparatus 31, the error location information receiving section 3109 receives error information transmitted from the data receiving apparatus 32 (step C102). Then, based on the received error information, the error type determining section 3108 determines the error type (step C103). Then, the error type-basis information calculating section 3107 calculates the error information for each error type (step C104). Subsequently, based on the calculated error information, the parameter calculating section 3102 calculates parameters (step C105). Then, according to the calculated parameters, the FEC processing section 3104 sets the FEC in the data from the data generating section 3105 (step C106). Finally, the data transmitting section 3101 transmits to the data receiving apparatus 32 the data in which the FEC has been set (step C107).

Referring to FIG. 10, in the data receiving apparatus 32, the data receiving section 3204 receives the data transmitted from the data transmitting apparatus 31 (step C202). Then, the network/data monitoring section 3203 monitors a state of the received data or state of the network (step C203). Subsequently, the error location information transmitting section 3208 transmits error location information to the data transmitting apparatus 31 (step C204).

The effect of the present exemplary embodiment will next be described.

According to the present exemplary embodiment, the same effect as the first exemplary embodiment can be obtained. Further, the data receiving apparatus 32 notifies the data transmitting apparatus 31 of error location information and the data transmitting apparatus 31 performs determination of the error type, calculation of the error information for each error type, and calculation of the FEC parameters, so that it is possible to determine or change a countermeasure against an error only by using the data transmitting apparatus.

### Fourth Exemplary Embodiment

A fourth exemplary embodiment of the present invention will next be described in detail.

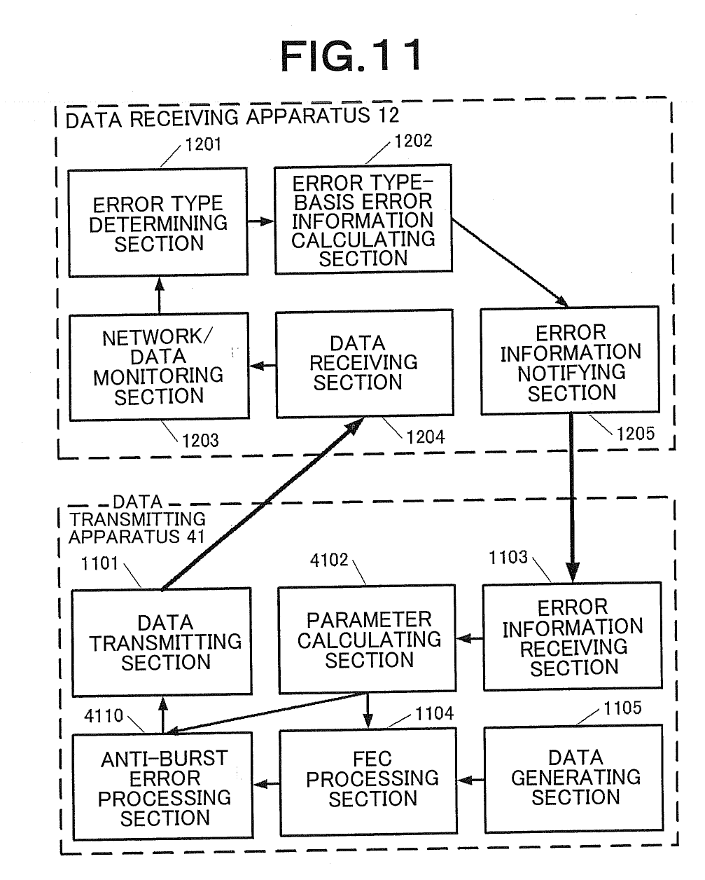

Referring to FIG. 11, a fourth exemplary embodiment of the present invention differs from the first exemplary embodiment (FIG. 2) in that it includes a data transmitting apparatus 41 in place of the data transmitting apparatus 11. The data transmitting apparatus 41 differs from the data transmitting apparatus 11 of FIG. 2 in that it includes a parameter calculating section 4102 in place of the parameter calculating apparatus 1102 and further includes an anti-burst error processing section 4110.

The anti-burst error processing section 4110 is a means for performing processing suitable for increasing burst error tolerance. Concrete examples of such processing include interleaving and convolution (disclosed in Non-Patent Document 1), and the anti-burst error processing section 4110 uses at least one of the above two processing. The interleaving is a technique to disperse data loss locations by dividing the input data stream into blocks and then changing the sequence of these blocks according to a given rule before transmission. This makes the burst error, if occurred during data transmission, appear to be random errors since when the data sequence is restored to the original sequence, the data loss locations are dispersed. The convolution disclosed in Non-Patent Document 1 is a technique in which, assuming that data is composed of blocks, information obtained by convolving previous some blocks is added to allow restoration of the original data if data lost occurs due to the burst error.

The parameter calculating section 4102 has a function of calculating parameters of the algorithm of the anti-burst error processing section 4110 in addition to the function of the parameter calculating section 1102 of the first exemplary embodiment. By changing the parameters, it is possible to set whether the interleaving or convolution is performed or not, range (block size) of the interleaving or convolution processing, or rearranging mode of the data sequence in the interleaving processing. The block size is calculated from the size of successive error which is determined as a burst error. The size of successive errors which are determined as a burst error is the size of successive errors that the error type-basis error information calculating section 1202 has determined as a burst error. The successive error size is then notified to the parameter calculating section 4102 through the error information notifying section 1205 and error information receiving section 1103. When the error successive size is 0, the parameter calculating section 4102 does not use the interleaving or convolution. When the error successive size is more than 0, the parameter calculating section 4102 uses the interleaving or convolution and sets one block of the data to the size more than the error successive size.

The operation in the present exemplary embodiment will next be described.

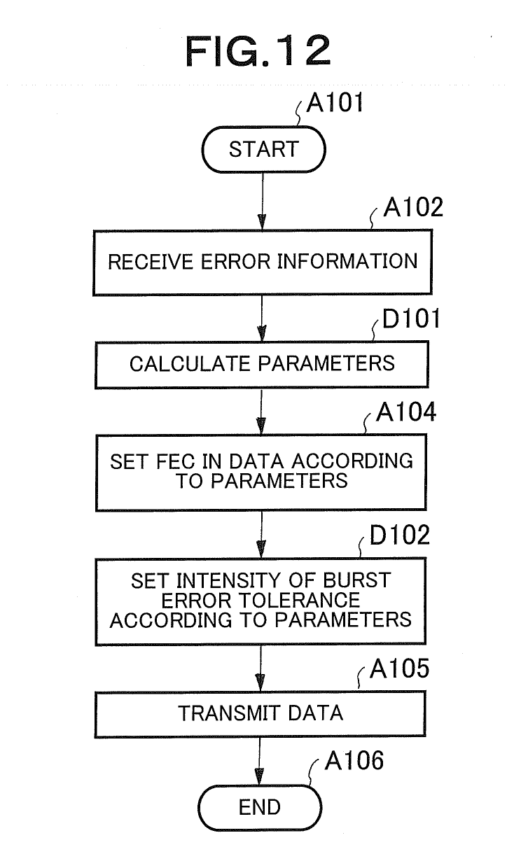

Referring to FIG. 12, the operation of the present exemplary embodiment differs from that of the first exemplary embodiment in that the anti-burst error processing section 4110 performs anti-burst error processing (D101) and that the parameter calculating section 4102 performs calculation processing (D102) of parameters of the algorithm of the anti-burst error processing section 4110 in addition to the function of the parameter calculating section 1102 of the first exemplary embodiment.

The effect of the present exemplary embodiment will next be described.

According to the present exemplary embodiment, the same effect as the first exemplary embodiment can be obtained. Further, a countermeasure can be taken against the burst error using an error correction technique suitable for the burst error, so that it is possible to increase burst error tolerance while reducing network bandwidth requirements as compared to a case where only the FEC is used.

As in the case where the first exemplary embodiment is modified to obtain the fourth exemplary embodiment, it is possible to modify the second and third exemplary embodiments to obtain another exemplary embodiment by newly adding the anti-burst error processing section and changing the operation or the sequence of the parameter calculating section.

### Fifth Exemplary Embodiment

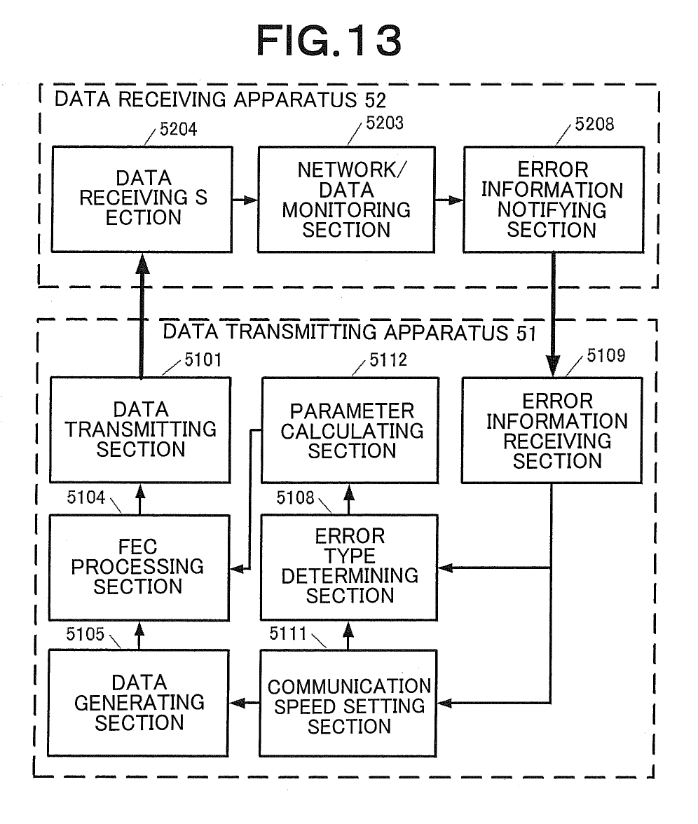

Referring to FIG. 13, a fifth exemplary embodiment of the present invention includes a data transmitting apparatus 51 for transmitting data and a data receiving apparatus 52 for receiving data from the data transmitting apparatus 51.

The data receiving apparatus 52 includes a network/data monitoring section 5203, data receiving section 5204, and an error information notifying section 5208. The function of the data receiving section 5204 is the same as that of the data receiving section 1204 of FIG. 2. Of the functions that the network/data monitoring section 1203 of FIG. 2 has, the network/data monitoring section 5203 achieves at least a function of monitoring the location at which an error has occurred before or/and after application of FEC correction. The error information notifying section 5208 is a means for transmitting statistical information about errors to the data transmitting apparatus 51.

The statistical information about errors transmitted from the data receiving apparatus 52 to data transmitting apparatus 51 is information statistically representing the locations at which data errors occur. Specifically, the statistical information is data error size and total data size per unit observation time before or/and after application of FEC correction, the number of data error packets and total number of data packets per unit observation time before or/and after application of FEC correction, or the ratio thereof. When the statistical information is notified, at least one of information concerning data-loss before application of FEC correction (state of data) and transmission delay, data arrival order, and signal condition (state of transmission path) may be added to the statistical information.

The data transmitting apparatus 51 includes a data transmitting section 5101, an FEC processing section 5104, a data generating section 5105, a parameter calculating section 5112, an error type determining section 5108, a communication speed setting section 5111, and an error information receiving section 5109.

The functions of the data transmitting section 5101, FEC processing section 5104, and data generating section 5105 are the same as those of the data transmitting section 1101, FEC processing section 1104, and data generating section 1105 which are shown in FIG. 2. The error information receiving section 5109 is a means for receiving the statistical information about errors transmitted from the data receiving apparatus 52.

The communication speed setting section 5111 is a means for setting communication speed based on error information or delay information calculated from the error information which is received from the error information receiving section 5109. Specifically, the communication speed setting section 5111 uses the error rate or delay information included in the error information to perform control such that it decreases communication speed as the error rate becomes higher or delay becomes larger; while it increases communication speed as the error rate becomes lower or delay becomes smaller. As the communication speed, data transmission amount per unit time (referred to as “transmission rate”), or data transmission amount per one round-trip time (referred to as “congestion window”) is used.

The error type determining section 5108 is a means for determining the type of an error based on the error information received from the error information receiving section 5109 and determining whether the FEC parameters are changed or not based on the determination result and communication speed acquired from the communication speed setting section 5111. The parameter calculating section 5112 is a means for calculating the FEC parameters according to the determination result of the error type determining section 5108 so as to change the current parameters.

The determination procedure is as follows. At the time when an event that increases the FEC redundancy degree occurs, to be more specific, when the error rate becomes higher, the FEC redundancy degree is not increased if the communication speed is not less than a predetermined threshold value; while the FEC redundancy degree is increased if the communication speed is less than a predetermined threshold value. Further, at the time when an event that decreases the FEC redundancy degree occurs, to be more specific, when a timer for decreasing the FEC redundancy degree times out, when the error rate becomes lower, or when a difference is generated between the error rates before and after application of the FEC correction, the FEC redundancy degree is decreased if the communication speed is not less than a predetermined threshold value; while the FEC redundancy degree is not decreased if the communication speed is less than a predetermined threshold value. The timer for decreasing the FEC redundancy degree is one or both of a timer periodically activated independently of the event that increases the FEC redundancy degree and a timer activated at the time when the FEC redundancy degree is increased.

The operation in the present exemplary embodiment will next be described.

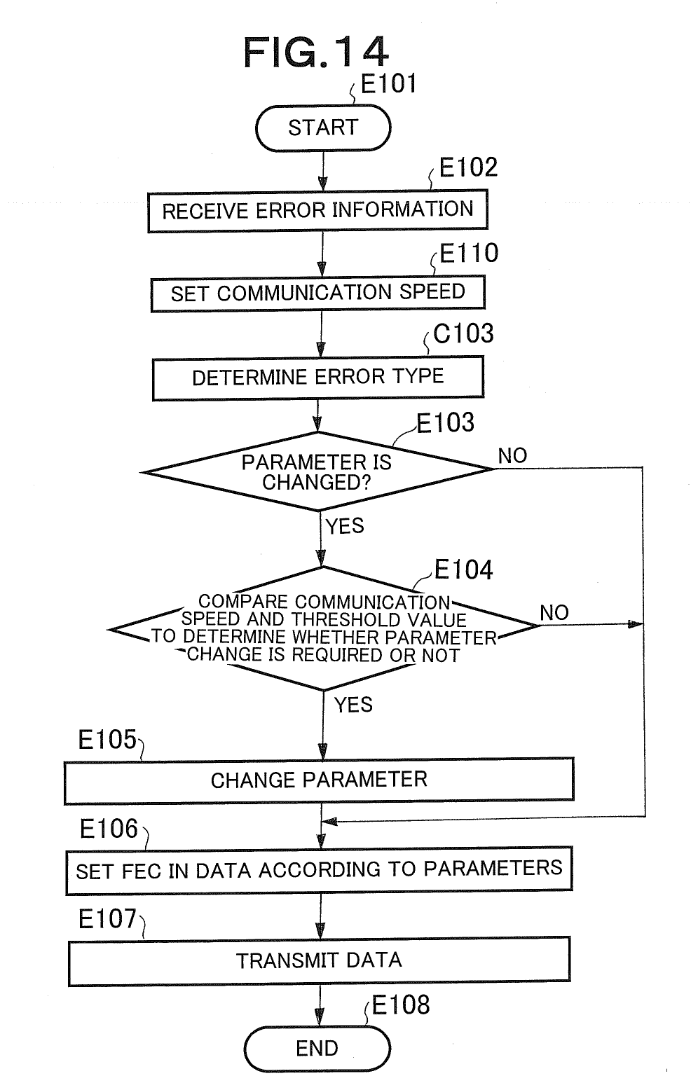

Referring to FIG. 14, in the data transmitting apparatus 51, the error information receiving section 5109 receives error information transmitted from the data receiving apparatus 52 (step E102). Then, based on the received error information or delay information calculated from the error information, the communication speed setting section 5111 sets communication speed (step E110).

In order to calculate the delay information from the error information, the following method is used. That is, the data transmitting section 5101 of the data transmitting apparatus 51 records data transmission time, the error information notifying section 5208 of the data receiving apparatus 52 adds the maximum sequence number of received data to the error information and transmits the error information added with the sequence number to the data transmitting apparatus 51, and the error information receiving section 5109 of the data transmitting apparatus 51 calculates a difference between the time at which the error information has been received and transmission time of the data having the sequence number corresponding to the error information, whereby the delay time can be calculated from the error information.

Further, in order to set communication speed based on the delay information, there is available a method in which the communication speed is decreased as the delay becomes larger, while the communication speed is increased as the delay becomes smaller.

Further, in order to set communication speed based on the error information and delay information, there is available a method using an expression for calculating the communication speed of a specific protocol from the error rate and delay amount. Specifically, an expression for calculating the communication speed obtained by modeling TCP and setting the error rate and delay amount as parameters is used.

Then, after determining the error type, the error type determining section 5108 determines whether a timing at which the redundancy degree parameter is changed has come (step E103). When determining that the timing has come, the error type determining section 5108 determines whether to change the redundancy degree parameter by comparing the communication speed and threshold value (step E104). After the error type determining section 5108 determines to change the redundancy degree parameter based on the comparison result, the parameter calculating section 6112 changes the redundancy degree parameter (step E105). Subsequently, according to the changed parameter, the FEC processing section 5104 sets the FEC in the data from the data generating section 5105 (step E106). Finally, the data transmitting section 5101 transmits to the data receiving apparatus 52 the data in which the FEC has been set (step E107).

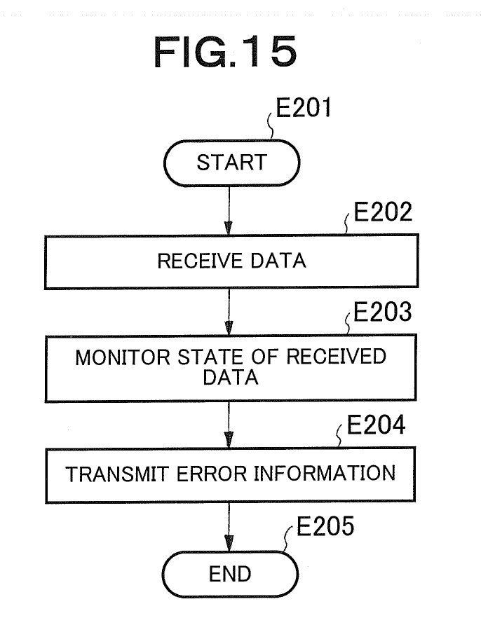

Referring to FIG. 15, in the data receiving apparatus 52, the data receiving section 5204 receives the data transmitted from the data transmitting apparatus 51 (step E202). Then, the network/data monitoring section 5203 monitors a state of the received data or state of the network (step E203). Subsequently, the error information notifying section 5208 transmits the information monitored by the network/data monitoring section 5203 to the data transmitting apparatus 51 (step E204).

The effect of the present exemplary embodiment will next be described.

According to the present exemplary embodiment, it is possible to acquire communication speed from a communication speed control function for setting communication speed in accordance with the increase or decrease of the error or delay amount and thereby to calculate the optimal FEC parameters in accordance with the communication speed. With this configuration, it is possible to change the FEC parameters in cooperation with the communication speed control function.

As in the case where the first exemplary embodiment is modified to obtain the fourth exemplary embodiment, it is possible to modify the fifth exemplary embodiment to obtain another exemplary embodiment by newly adding the anti-burst error processing section and changing the operation of the parameter calculating section.

### Sixth Exemplary Embodiment

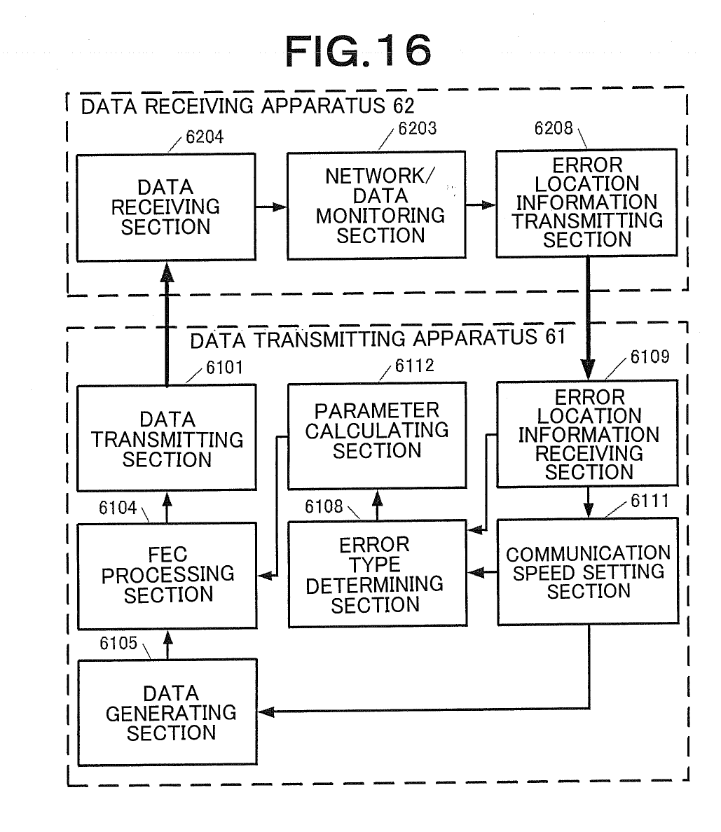

Referring to FIG. 16, a sixth exemplary embodiment of the present invention includes a data transmitting apparatus 61 for transmitting data and a data receiving apparatus 62 for receiving data from the data transmitting apparatus 61.

The data receiving apparatus 62 includes a network/data monitoring section 6203, data receiving section 6204, and an error location information transmitting section 6208. The function of the data receiving section 6204 is the same as that of the data receiving section 1204 of FIG. 2. Of the functions that the network/data monitoring section 1203 of FIG. 2 has, the network/data monitoring section 6203 achieves at least a function of monitoring the location at which an error has occurred after application of FEC correction. The error location information transmitting section 6208 is a means for transmitting error location information to the data transmitting apparatus 61.

The error location information is information that explicitly indicates the location at which a data error has occurred. As a concrete method for notifying the error location information, there are available a method (ACK: Acknowledgement) of giving notice of the sequence number of the data that has arrived in the data receiving apparatus 62, a method (NACK: Negative Acknowledgement) of giving notice of the sequence number of the data that has not arrived in the data receiving apparatus 62, and a method of combining the above two. When the error location information is notified, at least one of information concerning the location of an error that has occurred before application of FEC correction (state of data) and transmission delay, data arrival order, and signal condition (state of transmission path) may be added to the error location information.

The data transmitting apparatus 61 includes a data transmitting section 6101, an FEC processing section 6104, a data generating section 6105, a parameter calculating section 6112, an error type determining section 6108, an error location information receiving section 6109, and a communication speed setting section 6111.

The functions of the data transmitting section 6101, FEC processing section 6104 and data generating section 6105, are the same as those of the data transmitting section 1101, FEC processing section 1104, and data generating section 1105 which are shown in FIG. 2.

The error location information receiving section 6109 is a means for receiving error location information from the data receiving apparatus 62. The error location information receiving section 6109 has also a function of monitoring the transmission time of given data and reception time of information concerning the error location of the given data and calculating a difference between the two values, thereby measuring round-trip delay which is information concerning the network quality.

The communication speed setting section 6111 is a means for setting communication speed based on information received and measured by the error location information receiving section 6109. Specifically, the communication speed setting section 6111 uses at least one of error occurrence location, round-trip delay, and error rate to set communication speed. In the case where the error occurrence condition is used, the communication speed setting section 6111 performs control such that it increases communication speed when data is normally received; while it decreases communication speed when data is likely to be lost due to occurrence of an error. In the case where the round-trip delay is used, the communication speed setting section 6111 performs control such that it increases communication speed when the delay amount does not increase; while it decreases communication speed when the delay amount increases. In the case where the error rate is used, the communication speed setting section 6111 performs control such that it decreases communication speed when the error rate becomes higher; while it increases communication speed when the error rate becomes lower. As the communication speed, data transmission amount per unit time (referred to as “transmission rate”), or data transmission amount per one round-trip time (referred to as “congestion window”) is used.

The error type determining section 6108 determines the type of an error based on the error location information received from the error location information receiving section 6109 or magnitude of the communication speed acquired from the communication speed setting section 6111 and then determines whether the FEC parameters are changed or not. The parameter calculating section 6112 calculates the FEC parameters according to the determination result so as to change the current parameters.

The error type influences the communication speed. For example, in the case of TCP-Reno where communication speed is changed due to occurrence of an error, the communication speed decreases when the error rate becomes higher; while the communication speed increases when the error rate becomes lower. Especially, time-out is likely to occur at the time of occurrence of a burst error, so that the communication speed is likely to decrease. Further, in TCP-Vegas where control is performed based on the round-trip delay, when the round-trip delay increases, packets are accumulated in a queue of a repeater to increase congestion level. In this case, it is determined that an error is likely to occur and, thereby, the communication speed is decreased. When packets are not accumulated in the queue, the congestion level is not increased, so that it is determined that error is hard to occur and, thereby, the communication speed is increased. In particular, in a state where the queue is filled with packets and therefore the burst error is likely to occur, the communication speed is likely to decrease. For the reasons mentioned above, whether the error type is a burst error or not can be determined based only on the data communication speed.

The determination procedure is as follows. At the time when an event that increases the FEC redundancy degree occurs, to be more specific, at the time when the error location information receiving section 6109 receives the error location information, if the communication speed is not less than a predetermined threshold value, the FEC redundancy degree is not increased; while the FEC redundancy degree is increased if the communication speed is less than a predetermined threshold value. Further, at the time when an event that decreases the FEC redundancy degree occurs, to be more specific, when a timer for decreasing the FEC redundancy degree times out, or when a difference between the loss rates before and after application of the FEC correction is not less than a given threshold value, the FEC redundancy degree is decreased if the communication speed is not less than a predetermined threshold value; while the FEC redundancy degree is not decreased if the communication speed is less than a predetermined threshold value.

The operation in the present exemplary embodiment will next be described.

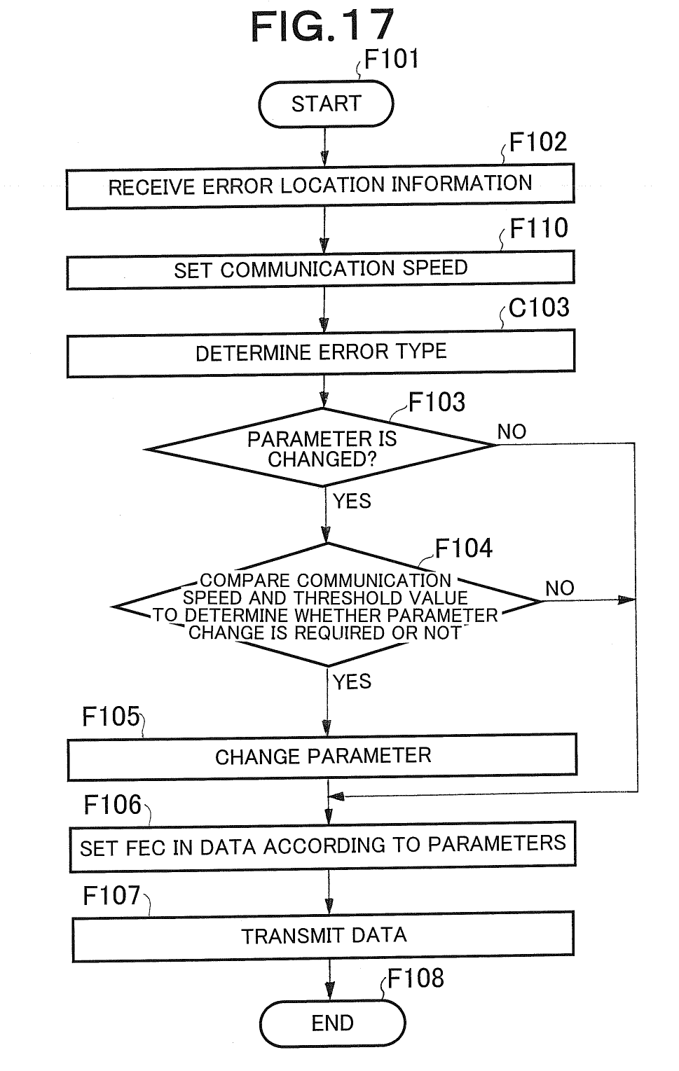

Referring to FIG. 17, in the data transmitting apparatus 61, the error location information receiving section 6109 receives error location information transmitted from the data receiving apparatus 62 (step F102). Then, based on the received error location information or delay information calculated from the error location information, the communication speed setting section 6111 sets communication speed (step F110). Subsequently, the error type determining section 6108 determines the error type based on the received error location information and set communication speed (step C103). The error type determining section 6108 then determines whether a timing at which the redundancy degree parameter is changed has come (step F103). When determining that the timing has come, the error type determining section 6108 determines whether to change the redundancy degree parameter by comparing the communication speed and threshold value (step F104). After the error type determining section 6108 determines to change the redundancy degree parameter based on the comparison result, the parameter calculating section 6112 changes the redundancy degree parameter (step F105). Subsequently, according to the changed parameter, the FEC processing section 6104 sets the FEC in the data from the data generating section 6105 (step F106). Finally, the data transmitting section 6101 transmits to the data receiving apparatus 62 the data in which the FEC has been set (step F107).

The operation of the data receiving apparatus 62 is the same as that of the data receiving apparatus 32 according to the third exemplary embodiment.

The data transmitting apparatus 61 according to the present exemplary embodiment may be added with a function of retransmitting the error location information received by the error location information receiving section 6109.

The effect of the present exemplary embodiment will next be described.

In the present exemplary embodiment, it is possible to acquire communication speed from the communication speed control function and thereby to calculate the optimal FEC parameters in accordance with the communication speed.

As in the case where the first embodiment is modified to obtain the fourth exemplary embodiment, it is possible to modify the sixth exemplary embodiment to obtain another exemplary embodiment by newly adding the anti-burst error processing section and changing the operation or sequence of the parameter calculating section.

In the present exemplary embodiment, the error location information transmitting section 6208, error location information receiving section 6109, and data generation section 6105 can exchange information using the existing TCP (Transport Control Protocol) stack. To exchange the error location information, ACK of the TCP is used. The TCP uses duplicate ACK numbers to give notice of data error. SACK (SelectiveACK) option may be used to explicitly indicate data loss location. In order to ensure the compatibility with the existing TCP, the FEC processing section 6104 identifies a segment including a redundant part by a flag set in an option field. As the communication speed, a value of congestion window of the TCP can be used. This is because that the value of congestion window corresponds to a value obtained by multiplying communication speed and round-trip delay, which means that the value of congestion window has a correlation with the increase and decrease of the communication speed. The redundant part may be included or may not be included in a flow control target by the congestion window of the TCP. The better is “to include”. This is because that the flow control by the congestion window enables transmission using a self-clocking scheme at an interval corresponding to the frequency band of a bottleneck queue.

Although, in the above exemplary embodiments of the present invention, the data transmitting apparatus and data receiving apparatus have a one-to-one relation, they may have a one-to-many, many-to-one, or many-to-many relation. That is, the exemplary embodiments are not limited to the number of the apparatuses or the number of combinations thereof. Further, by providing elements constituting the data transmitting apparatus and data receiving apparatus in the same apparatus, it is possible to realize a transmitting/receiving apparatus.

The present invention can be achieved as long as data is separated into packets or blocks and exchanged by use of protocol working over a network or data bus. Any data (such as voice data, image data, or the like) can be used in the present invention as long as it can be converted into digital data.

When the present invention is implemented on IP (Internet Protocol), UDP (User Datagram Protocol) or RTP (Real-time Transport Protocol) on the UDP is used as a packet format.

The function of the communication apparatus according to the present invention can be embodied not only by hardware but also by a combination of a computer and a program running in the computer. The program, which is recorded in a computer-readable recording medium such as a magnetic disk or semiconductor memory and read by the computer at its start-up time, controls the operation of the computer to thereby allow the computer to function as a communication apparatus in the abovementioned respective embodiments.

The present invention can be applied to an apparatus that performs communication using IP packets and a program for realizing communication using IP packets.

### Seventh Exemplary Embodiment

Furthermore, the seventh exemplary embodiment of the invention is a data communication apparatus that transmits/receives data through a communication network using an FEC (Forward Error Correction) which is a code for applying redundancy to the data, wherein the apparatus determines whether the error type, which is information concerning the pattern of an error of the data occurring on the communication network, is a burst error or not, and changes the redundancy degree of the FEC based on the error type.

### Eighth Exemplary Embodiment

Furthermore, the eighth exemplary embodiment of the invention is the data communication apparatus according to seventh exemplary embodiment, wherein the apparatus determines whether the error type is a burst error or not based on one or both of successive error size of the data and communication speed of the data.

### Ninth Exemplary Embodiment

Furthermore, the ninth exemplary embodiment of the invention is a data communication apparatus that transmits data through a communication network using an FEC (Forward Error Correction) which is a code for applying redundancy to the data, comprising: an error information receiving section that receives error type information which is information concerning the pattern of an error of the data occurring on the communication network; and a parameter calculating section that calculates parameters of the FEC based on the error type information.

### Tenth Exemplary Embodiment

Furthermore, the tenth exemplary embodiment of the invention is a data communication apparatus that transmits data through a communication network using an FEC (Forward Error Correction) which is a code for applying redundancy to the data, comprising: an error information receiving section that receives delay information of the data on the communication network and error type information which is information concerning the pattern of an error of the data occurring on the communication network; and a parameter calculating section that calculates parameters of the FEC based on one or both of the information concerning transmission quality and the error type information.

### Eleventh Exemplary Embodiment

Furthermore, the eleventh exemplary embodiment of the invention is the data communication apparatus according to the ninth or tenth exemplary embodiment, wherein the error type information that the error information receiving section receives indicates whether an error that has occurred is a burst error which represents a state where errors occur successively or a non-burst error which represents a state where errors occur intermittently.

### Twelfth Exemplary Embodiment

Furthermore, the twelfth exemplary embodiment of the invention is a data communication apparatus that receives data through a communication network using an FEC (Forward Error Correction) which is a code for applying redundancy to the data, comprising: a data monitoring section that monitors an error occurrence state of the received data; an error type determining section that determines the error type which is information concerning the pattern of an error of the data occurring on the communication network based on the error occurrence state of the data; and a parameter calculating section that calculates parameters of the FEC based on the error type.

### Thirteenth Exemplary Embodiment

Furthermore, the thirteenth exemplary embodiment of the invention is a data communication apparatus that receives data through a communication network using an FEC (Forward Error Correction) which is a code for applying redundancy to the data, comprising: a network/data monitoring section that monitors delay information of the data on the communication network and an error occurrence state of the received data; an error type determining section that determines the error type which is information concerning the pattern of an error of the data occurring on the communication network based on the data error occurrence state and delay information of the data; and a parameter calculating section that calculates parameters of the FEC for each error type.

### Fourteenth Exemplary Embodiment

Furthermore, the fourteenth exemplary embodiment of the invention is the data communication apparatus according to the twelfth or thirteenth exemplary embodiment, wherein the error type information that the error type determining section determines indicates whether an error that has occurred is a burst error which represents a state where errors occur successively or a non-burst error which represents a state where errors occur intermittently.

### Fifteenth Exemplary Embodiment

Furthermore, the fifteenth exemplary embodiment of the invention is a data communication apparatus that transmits data through a communication network using an FEC (Forward Error Correction) which is a code for applying redundancy to the data, comprising: an error location information receiving section that receives information concerning the location at which an error has occurred on a receiving side; an error type determining section that determines the error type which is information concerning the pattern of an error of the data occurring on the communication network based on the data error occurrence location; and a parameter calculating section that calculates parameters of the FEC based on the determined error type.

### Sixteenth Exemplary Embodiment

Furthermore, the sixteenth exemplary embodiment of the invention is a data communication apparatus that transmits data through a communication network using an FEC (Forward Error Correction) which is a code for applying redundancy to the data, comprising: an error location information receiving section that receives, from a receiving side, delay information of the data on the communication network and information concerning the location at which an error has occurred on the receiving side; an error type determining section that determines the error type which is information concerning the pattern of an error of the data occurring on the communication network based on the delay information of the data on the communication network and information concerning the data error occurrence location; and a parameter calculating section that calculates parameters of the FEC for each determined error type.

### Seventeenth Exemplary Embodiment

Furthermore, the Seventeenth exemplary embodiment of the invention is a data communication apparatus that transmits data through a communication network using an FEC (Forward Error Correction) which is a code for applying redundancy to the data, comprising: an error location information receiving section that receives information concerning the location at which an error has occurred on the receiving side; an error type determining section that measures information concerning transmission quality on the communication network based on the information concerning the location at which an error has occurred on the receiving side and determines the error type which is information concerning the pattern of an error of the data occurring on the communication network based on the information concerning the data error occurrence location and information concerning the transmission quality; and a parameter calculating section that calculates parameters of the FEC based on the determined error type.

### Eighteenth Exemplary Embodiment

Furthermore, the eighteenth exemplary embodiment of the invention is the data communication apparatus according to any one of the fifteen to eighteen exemplary embodiments, wherein the error type information that the error type determining section determines indicates whether an error that has occurred is a burst error which represents a state where errors occur successively or a non-burst error which represents a state where errors occur intermittently.

### Nineteenth Exemplary Embodiment

Furthermore, the nineteenth exemplary embodiment of the invention is a data communication apparatus that transmits/receives data through a communication network using an FEC (Forward Error Correction) which is a code for applying redundancy to the data, determines whether the error type, which is information concerning the pattern of an error of the data occurring on the communication network is a burst error which represents a state where errors occur successively or a non-burst error which represents a state where errors occur intermittently, and changes redundancy degree of the FEC according to the determined error type, comprising an anti-burst error processing section that performs interleaving to change the sequence of data blocks.

### Twentieth Exemplary Embodiment

Furthermore, the twentieth exemplary embodiment of the invention is the data communication apparatus according to the nineteenth exemplary embodiment, comprising a parameter calculating section that determines whether the interleaving is performed or not based on the error type and calculates the size of data blocks to which the interleaving is to be applied.

### Twenty-First Exemplary Embodiment

Furthermore, the twenty-first exemplary embodiment of the invention is a data communication apparatus that transmits/receives data through a communication network using an FEC (Forward Error Correction) which is a code for applying redundancy to the data, determines whether the error type, which is information concerning the pattern of an error of the data occurring on the communication network is a burst error which represents a state where errors occur successively or a non-burst error which represents a state where errors occur intermittently, and changes redundancy degree of the FEC according to the determined error type, comprising an anti-burst error processing section that adds redundancy codes obtained by convolving previous data blocks.

### Twenty-Second Exemplary Embodiment

Furthermore, the twenty-second exemplary embodiment of the invention is the data communication apparatus according to the twenty-first exemplary embodiment, comprising a parameter calculating section that determines whether the convolution is performed or not based on the error type and calculates the size of data blocks to which the convolution is to be applied.

### Twenty-Third Exemplary Embodiment

Furthermore, the twenty-third exemplary embodiment of the invention is a data communication apparatus that transmits data through a communication network using an FEC (Forward Error Correction) which is a code for applying redundancy to the data while performing communication speed control based on a data reception state including one or both of data error and delay on the communication network, wherein the apparatus determines whether the error type, which is information concerning the pattern of an error of the data occurring on the communication network, is a burst error or not and, according to the determined error type, calculates parameters of the FEC.

### Twenty-Fourth Exemplary Embodiment

Furthermore, the twenty-forth exemplary embodiment of the invention is a data communication apparatus that transmits data through a communication network using an FEC (Forward Error Correction) which is a code for applying redundancy to the data while performing communication speed control based on a data reception state including one or both of data error and delay on the communication network, comprising: an error type determining section that determines whether the error type, which is information concerning the pattern of an error of the data occurring on the communication network, is a burst error or not based on the information concerning the communication speed; and a parameter calculating section that calculates parameters of the FEC based on the determined error type.

### Twenty-Fifth Exemplary Embodiment

Furthermore, the twenty-fifth exemplary embodiment of the invention is the data communication apparatus according to the twenty-fourth exemplary embodiment, wherein whether the error type is a burst error or not is determined based on the magnitude of the data communication speed.

### Twenty-Sixth Exemplary Embodiment

Furthermore, the twenty-sixth exemplary embodiment of the invention is the data communication apparatus according to twenty-fifth exemplary embodiment, wherein the magnitude of the data communication speed is compared using a threshold value.

### Twenty-Seventh Exemplary Embodiment

Furthermore, the twenty-seventh exemplary embodiment of the invention is a data communication apparatus that transmits data through a communication network using an FEC (Forward Error Correction) which is a code for applying redundancy to the data while performing communication speed control based on a data reception state including one or both of data error and delay on the communication network, wherein the apparatus calculates parameters of the FEC from information concerning communication speed on the communication network.

### Twenty-Eighth Exemplary Embodiment

Furthermore, the twenty-eighth exemplary embodiment of the invention is a data communication apparatus that transmits data through a communication network using an FEC (Forward Error Correction) which is a code for applying redundancy to the data while performing communication speed control based on a data reception state including one or both of data error and delay on the communication network, comprising: an error type determining section that determines the error type which is information concerning the pattern of an error of the data occurring on the communication network based on the information concerning the communication speed; and a parameter calculating section that calculates parameters of the FEC based on the determined error type.

### Twenty-Ninth Exemplary Embodiment

Furthermore, the twenty-ninth exemplary embodiment of the invention is the data communication apparatus according to the twenty-eighth exemplary embodiment, wherein whether the error type is a burst error or not is determined based on the magnitude of the data communication speed.

### Thirtieth Exemplary Embodiment

Furthermore, the thirtieth exemplary embodiment of the invention is the data communication apparatus according to the twenty-ninth exemplary embodiment, wherein the magnitude of the data communication speed is compared using a threshold value.

### Thirty-First Exemplary Embodiment

Furthermore, the thirty-first exemplary embodiment of the invention is a data communication apparatus that transmits data through a communication network using an FEC (Forward Error Correction) which is a code for applying redundancy to the data while performing communication speed control based on a data reception state including one or both of data error and delay on the communication network, comprising: an error information receiving section that receives statistical information of the data errors on a receiving side; an error type determining section that determines the error type which is information concerning the pattern of an error of the data occurring on the communication network based on the statistical information of the data errors and data communication speed; and a parameter calculating section that calculates parameters of the FEC based on the determined error type.

### Thirty-Second Exemplary Embodiment

Furthermore, the thirty-second exemplary embodiment of the invention is the data communication apparatus according to the thirty-first exemplary embodiment, wherein whether the error type is a burst error or not is determined based on the magnitude of the data communication speed.

### Thirty-Third Exemplary Embodiment

Furthermore, the thirty-third exemplary embodiment of the invention is the data communication apparatus according to claim 26, wherein the magnitude of the data communication speed is compared using a threshold value.

### Thirty-Fourth Exemplary Embodiment

Furthermore, the thirty-fourth exemplary embodiment of the invention is a data communication apparatus that transmits data through a communication network using an FEC (Forward Error Correction) which is a code for applying redundancy to the data while performing communication speed control based on a data reception state including one or both of data error and delay on the communication network, comprising: an error location information receiving section that receives information concerning the location at which an error has occurred on a receiving side; an error type determining section that determines the error type which is information concerning the pattern of an error of the data occurring on the network based on the data error occurrence location and data communication speed; and a parameter calculating section that calculates parameters of the FEC based on the determined error type.

### Thirty-Fifth Exemplary Embodiment

Furthermore, the thirty-fifth exemplary embodiment of the invention is the data communication apparatus according to the thirty-fourth exemplary embodiment, wherein whether the error type is a burst error or not is determined based on the magnitude of the data communication speed.

### Thirty-sixth Exemplary Embodiment

Furthermore, the thirty-sixth exemplary embodiment of the invention is the data communication apparatus according to the thirty-fifth exemplary embodiment, wherein the magnitude of the data communication speed is compared using a threshold value.

### Thirty-Seventh Exemplary Embodiment

Furthermore, the thirty-seventh exemplary embodiment of the invention is the data communication apparatus according to the thirty-fourth exemplary embodiment, wherein the error location information received by the error location information receiving section is retransmitted.

### Thirty-Eighth Exemplary Embodiment

Furthermore, the thirty-eighth exemplary embodiment of the invention is the data communication apparatus according to the thirty-seventh exemplary embodiment, wherein a TCP (Transport Control Protocol) is used as a data communication protocol.

### Thirty-Ninth Exemplary Embodiment

Furthermore, the thirty-ninth exemplary embodiment of the invention is the data communication apparatus according to the thirty-eighth exemplary embodiment, wherein the error type determining section determines the error type based on the magnitude of a congestion window in the TCP.

### Fortieth Exemplary Embodiment

Furthermore, the fortieth exemplary embodiment of the invention is a data communication method that transmits/receives data through a communication network using an FEC (Forward Error Correction) which is a code for applying redundancy to the data, comprising: determining whether the error type, which is information concerning the pattern of an error of the data occurring on the communication network, is a burst error or not; and changing, according to the determined error type, the redundancy degree of the FEC.

### Forty-First Exemplary Embodiment

Furthermore, the forty-first exemplary embodiment of the invention is a data communication method that transmits data through a communication network using an FEC (Forward Error Correction) which is a code for applying redundancy to the data, comprising: enabling an error information receiving section to receive error type information which is information concerning the pattern of an error of the data occurring on the communication network; and enabling a parameter calculating section to calculate parameters of the FEC based on the error type information.

### Forty-Second Exemplary Embodiment

Furthermore, the forty-second exemplary embodiment of the invention is a data communication method that transmits data through a communication network using an FEC (Forward Error Correction) which is a code for applying redundancy to the data, comprising: enabling an error information receiving section to receive delay information of the data on the communication network and error type information which is information concerning the pattern of an error of the data occurring on the communication network; and enabling a parameter calculating section to calculate parameters of the FEC based on one or both of the information concerning transmission quality and the error type information.

### Forty-Third Exemplary Embodiment

Furthermore, the forty-third exemplary embodiment of the invention is a data communication method that receives data through a communication network using an FEC (Forward Error Correction) which is a code for applying redundancy to the data, comprising: enabling a data monitoring section to monitor an error occurrence state of the received data; enabling an error type determining section to determine the error type which is information concerning the pattern of an error of the data occurring on the communication network based on the error occurrence state of the data; and enabling a parameter calculating section to calculate parameters of the FEC based on the error type.

### Forty-Fourth Exemplary Embodiment

Furthermore, the forty-fourth exemplary embodiment of the invention is a data communication method that receives data through a communication network using an FEC (Forward Error Correction) which is a code for applying redundancy to the data, comprising: enabling a network/data monitoring section to monitor delay information of the data on the communication network and an error occurrence state of the received data; enabling an error type determining section to determine the error type which is information concerning the pattern of an error of the data occurring on the communication network based on the data error occurrence state and delay information of the data; and enabling a parameter calculating section to calculate parameters of the FEC for each error type.

### Forty-Fifth Exemplary Embodiment

Furthermore, the forty-fifth exemplary embodiment of the invention is a data communication method that transmits data through a communication network using an FEC (Forward Error Correction) which is a code for applying redundancy to the data, comprising: enabling an error location information receiving section to receive information concerning the location at which an error has occurred on a receiving side; enabling an error type determining section to determine the error type which is information concerning the pattern of an error of the data occurring on the communication network based on the data error occurrence location; and enabling a parameter calculating section to calculate parameters of the FEC based on the determined error type.

### Forty-Sixth Exemplary Embodiment

Furthermore, the forty-sixth exemplary embodiment of the invention is a data communication method that transmits data through a communication network using an FEC (Forward Error Correction) which is a code for applying redundancy to the data, comprising: enabling an error location information receiving section to receive, from a receiving side, delay information of the data on the communication network and information concerning the location at which an error has occurred on the receiving side; enabling an error type determining section to determine the error type which is information concerning the pattern of an error of the data occurring on the communication network based on the delay information of the data on the communication network and information concerning the data error occurrence location; and enabling a parameter calculating section to calculate parameters of the FEC for each determined error type.

### Forty-Seventh Exemplary Embodiment

Furthermore, the forty-seventh exemplary embodiment of the invention is a data communication method that transmits data through a communication network using an FEC (Forward Error Correction) which is a code for applying redundancy to the data, comprising: enabling an error location information receiving section to receive information concerning the location at which an error has occurred on the receiving side; enabling an error type determining section to measure information concerning transmission quality on the communication network based on the information concerning the location at which an error has occurred on the receiving side and determines the error type which is information concerning the pattern of an error of the data occurring on the communication network based on the information concerning the data error occurrence location and information concerning the transmission quality; and enabling a parameter calculating section to calculate parameters of the FEC based on the determined error type.

### Forty-Eighth Exemplary Embodiment

Furthermore, the forty-eighth exemplary embodiment of the invention is a data communication method that transmits/receives data through a communication network using an FEC (Forward Error Correction) which is a code for applying redundancy to the data, determines whether the error type, which is information concerning the pattern of an error of the data occurring on the communication network is a burst error which represents a state where errors occur successively or a non-burst error which represents a state where errors occur intermittently, and changes redundancy degree of the FEC according to the determined error type, the data communication method comprising enabling an anti-burst error processing section to perform interleaving to change the sequence of data blocks.

### Forty-Ninth Exemplary Embodiment

Furthermore, the forty-ninth exemplary embodiment of the invention is a data communication method that transmits/receives data through a communication network using an FEC (Forward Error Correction) which is a code for applying redundancy to the data, determines whether the error type, which is information concerning the pattern of an error of the data occurring on the communication network is a burst error which represents a state where errors occur successively or a non-burst error which represents a state where errors occur intermittently, and changes redundancy degree of the FEC according to the determined error type, the data communication method comprising enabling an anti-burst error processing section to add redundancy codes obtained by convolving previous data blocks.

### Fiftieth Exemplary Embodiment

Furthermore, the fiftieth exemplary embodiment of the invention is a data communication method that transmits data through a communication network using an FEC (Forward Error Correction) which is a code for applying redundancy to the data while performing communication speed control based on a data reception state including one or both of data error and delay on the communication network, the data communication method comprising determining whether the error type, which is information concerning the pattern of an error of the data occurring on the communication network, is a burst error or not and, according to the determined error type, calculates parameters of the FEC.

### Fifty-First Exemplary Embodiment

Furthermore, the fifty-first exemplary embodiment of the invention is a data communication method that transmits data through a communication network using an FEC (Forward Error Correction) which is a code for applying redundancy to the data while performing communication speed control based on a data reception state including one or both of data error and delay on the communication network, comprising: enabling an error type determining section to determine whether the error type, which is information concerning the pattern of an error of the data occurring on the communication network, is a burst error or not based on the information concerning the communication speed; and enabling a parameter calculating section to calculate parameters of the FEC based on the determined error type.

### Fifty-Second Exemplary Embodiment

Furthermore, the fifty-second exemplary embodiment of the invention is a data communication method that transmits data through a communication network using an FEC (Forward Error Correction) which is a code for applying redundancy to the data while performing communication speed control based on a data reception state including one or both of data error and delay on the communication network, the data communication method comprising calculating parameters of the FEC from information concerning communication speed on the communication network.

### Fifty-Third Exemplary Embodiment

Furthermore, the fifty-third exemplary embodiment of the invention is a data communication method that transmits data through a communication network using an FEC (Forward Error Correction) which is a code for applying redundancy to the data while performing communication speed control based on a data reception state including one or both of data error and delay on the communication network, comprising: enabling an error type determining section to determine the error type which is information concerning the pattern of an error of the data occurring on the communication network based on the information concerning the communication speed; and enabling a parameter calculating section to calculate parameters of the FEC based on the determined error type.

### Fifty-Fourth Exemplary Embodiment

Furthermore, the fifty-fourth exemplary embodiment of the invention is a data communication method that transmits data through a communication network using an FEC (Forward Error Correction) which is a code for applying redundancy to the data while performing communication speed control based on a data reception state including one or both of data error and delay on the communication network, comprising: enabling an error information receiving section to receive statistical information of the data errors on a receiving side; enabling an error type determining section to determine the error type which is information concerning the pattern of an error of the data occurring on the communication network based on the statistical information of the data errors and data communication speed; and enabling a parameter calculating section to calculate parameters of the FEC based on the determined error type.

### Fifty-Fifth Exemplary Embodiment

Furthermore, the fifty-fifth exemplary embodiment of the invention is a data communication method that transmits data through a communication network using an FEC (Forward Error Correction) which is a code for applying redundancy to the data while performing communication speed control based on a data reception state including one or both of data error and delay on the communication network, comprising: enabling an error location information receiving section to receive information concerning the location at which an error has occurred on a receiving side; enabling an error type determining section to determine the error type which is information concerning the pattern of an error of the data occurring on the network based on the data error occurrence location and data communication speed; and enabling a parameter calculating section to calculate parameters of the FEC based on the determined error type.

### Fifty-Sixth Exemplary Embodiment

Furthermore, the fifty-sixth exemplary embodiment of the invention is a program for operating a computer, configuring a data communication apparatus that transmits data through a communication network using an FEC (Forward Error Correction) which is a code for applying redundancy to the data, as: an error information receiving section that receives error type information which is information concerning the pattern of an error of the data occurring on the communication network; and a parameter calculating section that calculates parameters of the FEC based on the error type information.

### Fifty-Seventh Exemplary Embodiment

Furthermore, the fifty-seventh exemplary embodiment of the invention is a program for operating a computer, configuring a data communication apparatus that transmits data through a communication network using an FEC (Forward Error Correction) which is a code for applying redundancy to the data, as: an error information receiving section that receives error type information which is information concerning the pattern of an error of the data occurring on the communication network; and a parameter calculating section that calculates parameters of the FEC based on the error type information.

### Fifty-Eighth Exemplary Embodiment

Furthermore, the fifty-eighth exemplary embodiment of the invention is a program for operating a computer, configuring a data communication apparatus that transmits data through a communication network using an FEC (Forward Error Correction) which is a code for applying redundancy to the data, as: an error information receiving section that receives delay information of the data on the communication network and error type information which is information concerning the pattern of an error of the data occurring on the communication network; and a parameter calculating section that calculates parameters of the FEC based on one or both of the information concerning transmission quality and the error type information.

### Fifty-Ninth Exemplary Embodiment

Furthermore, the fifty-ninth exemplary embodiment of the invention is a program for operating a computer, configuring a data communication apparatus that receives data through a communication network using an FEC (Forward Error Correction) which is a code for applying redundancy to the data, as: a data monitoring section that monitors an error occurrence state of the received data; an error type determining section that determines the error type which is information concerning the pattern of an error of the data occurring on the communication network based on the error occurrence state of the data; and a parameter calculating section that calculates parameters of the FEC based on the error type.

### Sixtieth Exemplary Embodiment

Furthermore, the sixtieth exemplary embodiment of the invention is a program for operating a computer, configuring a data communication apparatus that receives data through a communication network using an FEC (Forward Error Correction) which is a code for applying redundancy to the data, as: a network/data monitoring section that monitors delay information of the data on the communication network and an error occurrence state of the received data; an error type determining section that determines the error type which is information concerning the pattern of an error of the data occurring on the communication network based on the data error occurrence state and delay information of the data; and a parameter calculating section that calculates parameters of the FEC for each error type.

### Sixty-First Exemplary Embodiment

Furthermore, the sixty-first exemplary embodiment of the invention is a program for operating a computer, configuring a data communication apparatus that transmits data through a communication network using an FEC (Forward Error Correction) which is a code for applying redundancy to the data, as: an error location information receiving section that receives information concerning the location at which an error has occurred on a receiving side; an error type determining section that determines the error type which is information concerning the pattern of an error of the data occurring on the communication network based on the data error occurrence location; and a parameter calculating section that calculates parameters of the FEC based on the determined error type.

### Sixty-Second Exemplary Embodiment

Furthermore, the sixty-second exemplary embodiment of the invention is a program for operating a computer, configuring a data communication apparatus that transmits data through a communication network using an FEC (Forward Error Correction) which is a code for applying redundancy to the data, as: an error location information receiving section that receives, from a receiving side, delay information of the data on the communication network and information concerning the location at which an error has occurred on the receiving side; an error type determining section that determines the error type which is information concerning the pattern of an error of the data occurring on the communication network based on the delay information of the data on the communication network and information concerning the data error occurrence location; and a parameter calculating section that calculates parameters of the FEC for each determined error type.

### Sixty-Third Exemplary Embodiment

Furthermore, the sixty-third exemplary embodiment of the invention is a program for operating a computer, configuring a data communication apparatus that transmits data through a communication network using an FEC (Forward Error Correction) which is a code for applying redundancy to the data, as: an error location information receiving section that receives information concerning the location at which an error has occurred on the receiving side; an error type determining section that measures information concerning transmission quality on the communication network based on the information concerning the location at which an error has occurred on the receiving side and determines the error type which is information concerning the pattern of an error of the data occurring on the communication network based on the information concerning the data error occurrence location and information concerning the transmission quality; and a parameter calculating section that calculates parameters of the FEC based on the determined error type.

### Sixty-Fourth Exemplary Embodiment

Furthermore, the sixty-fourth exemplary embodiment of the invention is a program for operating a computer, configuring a data communication apparatus that transmits/receives data through a communication network using an FEC (Forward Error Correction) which is a code for applying redundancy to the data, determines whether the error type, which is information concerning the pattern of an error of the data occurring on the communication network is a burst error which represents a state where errors occur successively or a non-burst error which represents a state where errors occur intermittently, and changes redundancy degree of the FEC according to the determined error type, as an anti-burst error processing section that performs interleaving to change the sequence of data blocks.

### Sixty-Fifth Exemplary Embodiment

Furthermore, the sixty-fifth exemplary embodiment of the invention is a program for operating a computer, configuring a data communication apparatus that transmits/receives data through a communication network using an FEC (Forward Error Correction) which is a code for applying redundancy to the data, determines whether the error type, which is information concerning the pattern of an error of the data occurring on the communication network is a burst error which represents a state where errors occur successively or a non-burst error which represents a state where errors occur intermittently, and changes redundancy degree of the FEC according to the determined error type, as an anti-burst error processing section that adds redundancy codes obtained by convolving previous data blocks.

### Sixty-Sixth Exemplary Embodiment

Furthermore, the sixty-sixth exemplary embodiment of the invention is a program for operating a computer, configuring a data communication apparatus that transmits data through a communication network using an FEC (Forward Error Correction) which is a code for applying redundancy to the data while performing communication speed control based on a data reception state including one or both of data error and delay on the communication network, as: an error type determining section that determines whether the error type, which is information concerning the pattern of an error of the data occurring on the communication network, is a burst error or not based on the information concerning the communication speed; and a parameter calculating section that calculates parameters of the FEC based on the determined error type.

### Sixty-Seventh Exemplary Embodiment

Furthermore, the sixty-seventh exemplary embodiment of the invention is a program for operating a computer, configuring a data communication apparatus that transmits data through a communication network using an FEC (Forward Error Correction) which is a code for applying redundancy to the data while performing communication speed control based on a data reception state including one or both of data error and delay on the communication network, as: an error type determining section that determines the error type which is information concerning the pattern of an error of the data occurring on the communication network based on the information concerning the communication speed; and a parameter calculating section that calculates parameters of the FEC based on the determined error type.

### Sixty-Eighth Exemplary Embodiment

Furthermore, the sixty-eighth exemplary embodiment of the invention is a program for operating a computer, configuring a data communication apparatus that transmits data through a communication network using an FEC (Forward Error Correction) which is a code for applying redundancy to the data while performing communication speed control based on a data reception state including one or both of data error and delay on the communication network, as: an error information receiving section that receives statistical information of the data errors on a receiving side; an error type determining section that determines the error type which is information concerning the pattern of an error of the data occurring on the communication network based on the statistical information of the data errors and data communication speed; and a parameter calculating section that calculates parameters of the FEC based on the determined error type.

### Sixty-Ninth Exemplary Embodiment

Furthermore, the sixty-ninth exemplary embodiment of the invention is a program for operating a computer, configuring a data communication apparatus that transmits data through a communication network using an FEC (Forward Error Correction) which is a code for applying redundancy to the data while performing communication speed control based on a data reception state including one or both of data error and delay on the communication network, as: an error location information receiving section that receives information concerning the location at which an error has occurred on a receiving side; an error type determining section that determines the error type which is information concerning the pattern of an error of the data occurring on the network based on the data error occurrence location and data communication speed; and a parameter calculating section that calculates parameters of the FEC based on the determined error type.

### Seventieth Exemplary Embodiment

Furthermore, the seventieth exemplary embodiment of the invention is a program for causing a computer to perform a data communication method for transmitting/receiving data through a communication network using an FEC (Forward Error Correction) which is a code for applying redundancy to the data, the data communication method comprising: determining whether the error type, which is information concerning the pattern of an error of the data occurring on the communication network, is a burst error or not; and changing, according to the determined error type, the redundancy degree of the FEC.

### Seventy-First Exemplary Embodiment

Furthermore, the seventy-first exemplary embodiment of the invention is a program for causing a computer to perform a data communication method for transmitting data through a communication network using an FEC (Forward Error Correction) which is a code for applying redundancy to the data while performing communication speed control based on a data reception state including one or both of data error and delay on the communication network, the data communication method comprising: determining whether the error type, which is information concerning the pattern of an error of the data occurring on the communication network, is a burst error or not; and calculating parameters of the FEC based on the error type.

### Seventy-Second Exemplary Embodiment

Furthermore, the seventy-first exemplary embodiment of the invention is a program for causing a computer to perform a data communication method for transmitting data through a communication network using an FEC (Forward Error Correction) which is a code for applying redundancy to the data while performing communication speed control based on a data reception state including one or both of data error and delay on the communication network, the data communication method comprising: calculating parameters of the FEC from information concerning communication speed on the communication network.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2007-017738 filed on Jan. 29, 2007, the disclosure of which is incorporated herein in its entirety by reference.

What is claimed is:

1. A data communication apparatus for transmitting/receiving data through a communication network using an FEC (Forward Error Correction) which is a code for applying redundancy to the data, comprising:
means for determining whether the error type, which is information concerning the pattern of an error of the data occurring on the communication network, is a burst error or not; and
means for changing the redundancy degree of the FEC based on the error type.

2. The data communication apparatus according to claim 1, wherein
said means for determining determines whether the error type is a burst error or not based on one or both of successive error size of the data and communication speed of the data.

3. The data communication apparatus according to claim 1, further comprising:
an error information receiving section configured to receive error type information which is information concerning the pattern of an error of the data occurring on the communication network; and
a parameter calculating section configured to calculate parameters of the FEC based on the error type information.

4. The data communication apparatus according to claim 3, wherein
the error information receiving section is configured to receive delay information of the data on the communication network and error type information which is information concerning the pattern of an error of the data occurring on the communication network; and
the parameter calculating section is configured to calculate parameters of the FEC based on one or both of the information concerning transmission quality and the error type information.

5. The data communication apparatus according to claim 1, further comprising:
a data monitoring section configured to monitor an error occurrence state of the received data;
an error type determining section configured to determine the error type which is information concerning the pattern of an error of the data occurring on the communication network based on the error occurrence state of the data; and
a parameter calculating section configured to calculate parameters of the FEC based on the error type.

6. The data communication apparatus according to claim 5, wherein
the data monitoring section is configured to monitor delay information of the data on the communication network and an error occurrence state of the received data;
the error type determining section is configured to determine the error type which is information concerning the pattern of an error of the data occurring on the communication network based on the data error occurrence state and delay information of the data; and
the parameter calculating section is configured to calculate parameters of the FEC for each error type.

7. The data communication apparatus according to claim 1, further comprising:
an error location information receiving section configured to receive information concerning the location at which an error has occurred on a receiving side;
an error type determining section configured to determine the error type which is information concerning the pattern of an error of the data occurring on the communication network based on the data error occurrence location; and
a parameter calculating section configured to calculate parameters of the FEC based on the determined error type.

8. The data communication apparatus according to claim 7, wherein
the error location information receiving section is configured to receive, from a receiving side, delay information of the data on the communication network and information concerning the location at which an error has occurred on the receiving side;
the error type determining section is configured to determine the error type which is information concerning the pattern of an error of the data occurring on the communication network based on the delay information of the data on the communication network and information concerning the data error occurrence location; and
the parameter calculating section is configured to calculate parameters of the FEC for each determined error type.

9. the data communication apparatus according to claim 7, wherein
the error location information receiving section is configured to receive information concerning the location at which an error has occurred on the receiving side;
the error type determining section is configured to
measure information concerning transmission quality on the communication network based on the information concerning the location at which an error has occurred on the receiving side and
determine the error type which is information concerning the pattern of an error of the data occurring on the communication network based on the information concerning the data error occurrence location and information concerning the transmission quality; and
the parameter calculating section is configured to calculate parameters of the FEC based on the determined error type.

10. The data communication apparatus according to claim 1, further comprising:
an anti-burst error processing section configured to perform interleaving to change the sequence of data blocks.

11. The data communication apparatus according to claim 1, further comprising:
an anti-burst error processing section configured to add redundancy codes obtained by convolving previous data blocks.

12. A data communication apparatus for transmitting data through a communication network using an FEC (Forward Error Correction) which is a code for applying redundancy to the data while performing communication speed control based on a data reception state including one or both of data error and delay on the communication network, comprising:
means for determining whether the error type, which is information concerning the pattern of an error of the data occurring on the communication network, is a burst error or not: and
means for calculating parameters of the FEC based on the error type.

13. The data communication apparatus according to claim 12, further comprising:
an error type determining section configured to determine whether the error type, which is information concerning the pattern of an error of the data occurring on the communication network, is a burst error or not based on the information concerning the communication speed; and
a parameter calculating section configured to calculate parameters of the FEC based on the determined error type.

14. A data communication apparatus for transmitting data through a communication network using an FEC (Forward Error Correction) which is a code for applying redundancy to the data while performing communication speed control based on a data reception state including one or both of data error and delay on the communication network, comprising:
means for calculating parameters of the FEC from information concerning communication speed on the communication network.

15. The data communication apparatus according to claim 14, further comprising:
an error type determining section configured to determine the error type which is information concerning the pattern of an error of the data occurring on the communication network based on the information concerning the communication speed; and
a parameter calculating section configured to calculate parameters of the FEC based on the determined error type.

16. The data communication apparatus according to claim 14, further comprising:
an error information receiving section configured to receive statistical information of the data errors on a receiving side;
an error type determining section configured to determine the error type which is information concerning the pattern of an error of the data occurring on the communication network based on the statistical information of the data errors and data communication speed; and
a parameter calculating section configured to calculate parameters of the FEC based on the determined error type.

17. The data communication apparatus according to claim 14, further comprising:
an error location information receiving section that receives information concerning the location at which an error has occurred on a receiving side;
an error type determining section configured to determine the error type which is information concerning the pattern of an error of the data occurring on the network based on the data error occurrence location and data communication speed; and
a parameter calculating section configured to calculate parameters of the FEC based on the determined error type.

18. A data communication method for transmitting/receiving data through a communication network using an FEC (Forward Error Correction) which is a code for applying redundancy to the data, comprising:
determining whether the error type, which is information concerning the pattern of an error of the data occurring on the communication network, is a burst error or not; and
changing, according to the determined error type, the redundancy degree of the FEC.

19. A data communication method for transmitting data through a communication network using an FEC (Forward Error Correction) which is a code for applying redundancy to the data while performing communication speed control based on a data reception state including one or both of data error and delay on the communication network, the data communication method comprising:
determining whether the error type, which is information concerning the pattern of an error of the data occurring on the communication network, is a burst error or not; and
calculating parameters of the FEC based on the error type.

20. A data communication method for transmitting data through a communication network using an FEC (Forward Error Correction) which is a code for applying redundancy to the data while performing communication speed control based on a data reception state including one or both of data error and delay on the communication network, the data communication method comprising:
calculating parameters of the FEC from information concerning communication speed on the communication network.

21. A program for causing a computer to perform a data communication method for transmitting/receiving data through a communication network using an FEC (Forward Error Correction) which is a code for applying redundancy to the data, the data communication method comprising:
determining whether the error type, which is information concerning the pattern of an error of the data occurring on the communication network, is a burst error or not; and
changing, according to the determined error type, the redundancy degree of the FEC.

22. A program for causing a computer to perform a data communication method for transmitting data through a communication network using an FEC (Forward Error Correction) which is a code for applying redundancy to the data while performing communication speed control based on a data reception state including one or both of data error and delay on the communication network, the data communication method comprising:
determining whether the error type, which is information concerning the pattern of an error of the data occurring on the communication network, is a burst error or not; and
calculating parameters of the FEC based on the error type.

23. A program for causing a computer to perform a data communication method for transmitting data through a communication network using an FEC (Forward Error Correction) which is a code for applying redundancy to the data while performing communication speed control based on a data reception state including one or both of data error and delay on the communication network, the data communication method comprising:
calculating parameters of the FEC from information concerning communication speed on the communication network.
